(19) United States
(12) Patent Application Publication
(10) Pub. No.: US 2006/0258816 A1
(43) Pub. Date: Nov. 16, 2006

(54) Flame-retardant styrenic resin composition

(76) Inventor: Shigeru Endo, Tokyo (JP)

Correspondence Address: STAAS & HALSEY LLP, SUITE 700, 1201 NEW YORK AVENUE, N.W., WASHINGTON, DC, 20005, US

(21) Appl. No.: 10/550,946

(22) PCT Filed: Mar. 26, 2004
(86) PCT No.: PCT/JP04/04337

§ 371 Date: Sep. 28, 2005

(30) Foreign Application Priority Data
Mar. 28, 2003 (JP) 2003-090859
Oct. 16, 2003 (JP) 2003-356211
Oct. 17, 2003 (JP) 2003-357404

(51) Int. Cl. C08L 71/12; C08K 5/49

(52) U.S. Cl. 525/391; 524/117; 524/121; 524/128

(57) ABSTRACT

The present invention provides a fire-retarding styrenic resin composition comprising (A) 100 parts by weight of a styrenic resin having a residue after thermal weight loss below 20% at 500° C., and (B) 0.5 to 50 parts by weight of a halogen compound-free fire retardant component, wherein the component (B) has a molecular weight of 200 to 2000, is dispersed in the form of circular or oval particles having an area-average particle size of 0.01 to 3 μm in the component (A), and has a residue after thermal weight loss of 20% or more at 500° C. and a melting point of 100 to 400° C.

### TECHNICAL FIELD

The present invention relates to a halogen compound-free, fire-retardant styrenic resin composition excellent in fire retardancy, more specifically a fire-retardant resin composition of well-balanced-fire retardancy, rigidity, heat resistance, fluidity, falling dart impact strength and outer appearances, and which is also excellent in releasability and mold contamination resistance.

### BACKGROUND ART

A styrenic resin has been widely used as an inexpensive, common resin having balanced properties of impact strength, moldability, rigidity and the like in various areas, including electric/electronic devices, OA devices and food wrapping materials. Of these products, electric/electronic devices, OA devices and the like are often required to be fire-retardant, and a styrenic resin composition of a styrenic resin incorporated with a fire retardant has been widely used for these areas. A halogen-based fire retardant has been widely used to make a styrenic resin fire-retardant. More recently, however, a fire-retarding styrenic resin incorporated with a nonhalogen-based fire retardant has been increasingly in demand for environmental reasons, including prevention of the evolution of corrosive gases.

The electric/electronic products in which a styrenic resin composition is used, including large-sized ones, e.g., TV sets and copiers, and relatively small-sized ones, e.g., office device internal components and external components such as an audio device, have often been of thin-wall and complex shape, and hence become difficult to mold. Therefore, halogen-free, fire-retardant styrenic resin compositions for these products are required to exhibit various properties, not only those generally required, e.g., fire retardancy, impact strength, heat resistance, rigidity and fluidity, but also other properties, e.g., good releasability to prevent galling and surface scratches when the products are released out of a mold, good outer appearances, fluidity even for thin-wall molded pieces, and falling dart impact strength and mold contamination resistance to prevent cracking even for thin-wall molded pieces.

A self-extinguishing, fire-retardant styrenic resin material has been in demand for thin-wall products, because the fire retardancy tends to deteriorate as the product thickness decreases. In particular, a conventional halogen-containing, fire-retardant styrenic V-2 resin immediately exhibits self-extinguishing tendency when dripped, but a dripped halogen-free, fire-retardant styrenic V-2 resin frequently continues to burn once ignited because of its low self-extinguishing capacity. Therefore, a halogen-free, fire-retardant styrenic V-2 resin is also required to be self-extinguishing, when dripped.

Fire-retardant resins which include a polyphenylene ether or polycarbonate have been extensively developed to satisfy the above requirement. When burnt, a polyphenylene ether and polycarbonate produce a fairly large quantity of char, which covers the surface, thereby delaying the supply of decomposition gases evolving within the resin to the combustion field, and then imparting fire retardancy to the resin. These resins exhibit a still higher fire retarding effect, when incorporated with a phosphorus- or silicon-based fire retardant. However, a polyphenylene ether is disadvantageous in that it is insufficient in fluidity, and in moldability when it is used for a fire-retardant resin composition. A polycarbonate, on the other hand, is insufficient in moldability, and also in recyclability because it is hydrolyzable.

On the other hand, a resin which produces no char when burnt is in itself easy to burn. It generally needs a large quantity of fire retardant, when made fire-retardant without using a halogen compound, i.e., with a non-halogen fire retardant. Therefore, it is difficult to balance fire retardancy of the resin composition with its other physical properties. For example, a styrenic resin, producing only a limited quantity of char when burnt, is inherently very low in fire retardancy. These resins have been made fire-retardant with a halogen-based fire retardant, and involve difficulty for achieving fire retardancy when a halogen-based fire retardant cannot be used. The conventional techniques for producing fire-retardant resins without using a halogen-based fire retardant include those incorporating red phosphorus, organic phosphorus-based fire retardant, polyphenylene ether, polycarbonate, inorganic fire retardant or silicon-based fire retardant. The one using red phosphorus involves safety-related problems because of the evolution of phosphine gas, and another disadvantage of deteriorating the outer appearances of the product. The other fire retardants listed above have the following disadvantages; the incorporation of common organic phosphorus-based fire retardant deteriorates heat resistance and rigidity; the incorporation of polyphenylene ether deteriorates moldability; the incorporation of polycarbonate deteriorates moldability and recyclability; the incorporation of inorganic fire retardant, in itself insufficient in fire-retarding capacity, deteriorates impact strength; and the incorporation of silicon-based fire retardant makes it difficult to make the product sufficiently fire-retardant while involving a high raw material cost.

In particular, with the tendency of products becoming thinner, the incorporation of an inorganic fire retardant is considered to be effective because it can improve the rigidity of the product. However, conventional inorganic fire retardants are insufficient in fire retarding capacity, and tend to greatly deteriorate impact strength and the outer appearances of the products.

Moreover, a fire-retardant resin composition generally tends to have deteriorated releasability, when incorporated with a variety of fire retardants. A fairly large quantity of releasing agent, e.g., a metallic salt of a higher fatty acid or aliphatic amide compound, has been incorporated to solve the above problems. However, incorporation of a releasing agent may cause problems, e.g., deteriorated physical properties of the product and contamination of the mold.

JP-A-2002-155179 discloses a fire-retardant resin composition containing a fire-retardant component of specific properties, mainly composed of styrenic resin having sulfonic acid groups, in an attempt to solve the above problems. This composition exhibits excellent effects with respect to impact strength, heat resistance, fluidity and outer appearances. However, production of a styrenic resin having sulfonic acid groups is not common. Moreover, the disclosure is silent about rigidity, releasability and mold contamination resistance associated with the composition.

JP-A-05-163288, U.S. Pat. No. 4,162,278 and JP-A-2002-037973 disclose a highly heat-resistant, fire-retardant styrenic resin composition incorporated with a phosphorus-based fire retardant. However, JP-A-05-163288 discloses only a fire-retardant styrenic resin composition incorporated with a polyphenylene ether at a high content. It is expected that such a resin composition has deteriorated fluidity (in particular for thin-wall products). Moreover, the disclosure is silent about outer appearances, releasability and mold contamination resistance associated with the composition. U.S. Pat. No. 4,162,278 and JP-A-2002-037973 disclose a fire-retardant styrenic resin composition, mainly composed of polystyrenic resin and containing the phosphorus-based fire retardant. A resin mainly composed of polystyrene is generally expected to have greatly deteriorated impact strength, when incorporated with the phosphorus-based fire retardant. These patent documents, however, are silent about a method for improving impact strength, and also about rigidity, outer appearances, fluidity for thin-wall products, releasability and mold contamination resistance associated with the composition.

The National Publication of International Patent Application No. 2002-526585 discloses a fire-retardant and thermoplastic styrenic polymer composition excellent in heat resistance and fire retardancy, like JP-A-2002-037973, JP-A-05-163288 and U.S. Pat. No. 4,162,278. However, the styrenic resin greatly loses impact strength, when incorporated with a fire retardant. Moreover, the patent document is silent about fluidity (in particular that for thin-wall products), rigidity, releasability and outer appearances associated with the composition.

As discussed above, it is difficult for the conventional techniques to impart fire retardancy to a styrenic resin, which is low in char-producing capacity and easy to burn, with a nonhalogen-based fire retardant while keeping the resulting fire-retardant resin composition well-balanced in the physical properties listed above.

### DISCLOSURE OF THE INVENTION

It is an object of the present invention to provide a fire-retardant resin composition well-balanced in physical properties of fire retardancy, heat resistance, fluidity and impact strength, and also excellent in releasability and mold contamination resistance, wherein the resin, such as a styrenic resin known as being low in char-producing capacity and easy to burn, is incorporated with a halogen compound-free fire retardant component to have improved fire retardancy.

It is another object of the present invention to provide a fire-retarding resin composition high in rigidity and well-balanced in physical properties of fire retardancy of the dripped composition, impact strength, heat resistance, fluidity and outer appearances, wherein the resin, such as styrenic resin known as being low in char-producing capacity and easy to burn, is incorporated with a halogen compound-free fire retardant component to have improved fire retardancy.

It is still another object of the present invention to provide a fire-retarding styrenic resin composition well-balanced in physical properties of rigidity, heat resistance, fluidity for thin-wall products, falling dart impact strength and outer appearances, and also excellent in releasability and resistance to mold contamination, wherein the easy-to-burn resin mainly composed of a rubber-modified styrenic resin is incorporated with a halogen compound-free fire retardant component to have improved fire retardancy.

It has been found, after extensive studies, that a fire-retardant styrenic resin composition can satisfy the above objects when a styrenic resin low in char-producing capacity is finely dispersed with a fire retardant component having (i) a molecular weight in a specific range, (ii) char-producing capacity while being burnt and a melting point in a specific temperature range, and (iii) no halogen compound, the latter having an area-average particle size in a specific range. It has also been found that a still better fire-retardant styrenic resin composition can be realized when the ratio of an area-average particle size of the rubber-like polymer particles to be dispersed in the rubber-modified styrenic resin to that of the fire retardant component particles falls within a specific range, satisfying the above objects and achieving the present invention.

The present invention has the following attributes.

[1] A fire-retardant styrenic resin composition comprising

(A) 100 parts by weight of a styrenic resin having a residue after thermal weight loss of below 20% at 500° C., and

(B) 0.5 to 50 parts by weight of a halogen compound-free fire retardant component,

said component (B) having a molecular weight of 200 to 2000, being dispersed in the form of circular or oval particles having an area-average particle size of 0.01 to 3 μm in the component (A), having a residue after thermal weight loss of 20% or more at 500° C. and having a melting point of 100 to 400° C.

[2] The fire-retardant styrenic resin composition according to [1], wherein the component (A) is a rubber-modified styrenic resin, and a rubber-like polymer dispersed in the component (A) has an area-average particle size of 0.1 to 2.5 μm and satisfies the following formula (1):
0.01≦(Df/Dr)≦1.0 (1)
wherein Df is an area-average particle size of the component (B) and Dr is an area-average particle size of the rubber-like polymer dispersed in the component (A).
[3] The fire-retardant styrenic resin composition according to [1] or [2], wherein the component (A) is a rubber-modified styrenic resin and the composition comprises 100 parts by weight of the component (A) and 0.5 to 20 parts by weight of the component (B).
[4] The fire-retardant styrenic resin composition according to any one of [1] to [3], wherein the component (A) is a rubber-modified styrenic resin, the composition comprises 100 parts by weight of the component (A) and 0.5 to 10 parts by weight of the component (B), and the rubber-like polymer dispersed in the component (A) has an area-average particle size of 0.1 to 2.5 μm and satisfies the following formula (2):
0.04≦(Df/Dr)≦1.0 (2)
wherein Df is an area-average particle size of the component (B) and Dr is an area-average particle size of the rubber-like polymer dispersed in the component (A).
[5] The fire-retardant styrenic resin composition according to any one of [1] to [4], wherein the component (A) is a rubber-modified styrenic resin comprising a blend of a rubber-modified polystyrenic resin and polyphenylene ether, the content of the rubber-modified polystyrenic resin in the blend being 70% by weight or more.
[6] The fire-retardant styrenic resin composition according to [5], wherein the component (A) consists of a blend comprised of 100 parts by weight of the rubber-modified polystyrenic resin and 0.1 to 45 parts by weight of the polyphenylene ether, the content of the component (B) in the composition being 0.5 to 20 parts by weight, and the rubber-like polymer dispersed in the component (A) having an area-average particle size of 0.3 to 2.5 μm.
[7] The fire-retardant styrenic resin composition according to [5] or [6], wherein the rubber-modified styrenic resin as component (A) consists of a blend comprised of 100 parts by weight of the rubber-modified polystyrenic resin wherein 0.1 to 8 parts by weight of the polyphenylene ether, wherein the content of the component (B) in the composition is 0.5 to 10 parts by weight.
[8] The fire-retardant styrenic resin composition according to any one of [5] to [7], wherein the incorporated part (X) of the polyphenylene ether in the component (A) and the incorporated part (Y) of the component (B) satisfy the following formula (3).
0.4≦(Y/X)≦2.0 (3)
[9] The fire-retardant styrenic resin composition according to any one of [1] to [8], wherein component (C), which is a halogen compound-free fire retardant component other than the component (B), is incorporated into the composition in an amount of 0.1 to 40 parts by weight.
[10] The fire-retardant styrenic resin composition according to [9], wherein the component (C) is incorporated into the composition in an amount of 0.1 to 10 parts by weight.
[11] The fire-retardant styrenic resin composition according to [9] or [10], wherein the content of the component (C) in the composition is not more than that of the component (B).
[12] The fire-retardant styrenic resin composition according to any one of [1] to [11], wherein a polymer component (D) comprising an essential structural unit having at least one polar group is further incorporated as a compatibilizer in an amount of 0.2 to 10 parts by weight.
[13] The fire-retardant styrenic resin composition according to any one of [1] to [12], wherein the component (B) is a phosphorus-based fire retardant represented by the following formula (4): 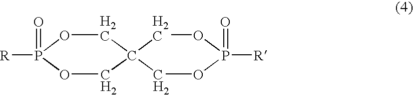
wherein R and R′ are each an alkyl group having 1 to 12 carbon atoms, a cycloalkyl group having 5 to 10 carbon atoms, an aralkyl group having 7 to 20 carbon atoms or an aryl group having 6 to 15 carbon atoms, and may be the same or different.
[14] The fire-retardant styrenic resin composition according to [13], wherein both R and R′ in the formula (4) are a benzyl group.
[15] The fire-retardant styrenic resin composition according to any one of [1] to [12], wherein the component (B) is a phosphorus-based fire retardant represented by the following formula (5): 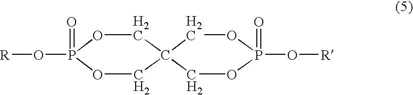
wherein R and R′ are each an alkyl group having 1 to 12 carbon atoms, a cycloalkyl group having 5 to 10 carbon atoms, an aralkyl group having 7 to 20 carbon atoms or an aryl group having 6 to 15 carbon atoms, and may be the same or different.
[16] The fire-retardant styrenic resin composition according to any one of [7] to [15], wherein the component (C) comprises a compound represented by the following formula (6): 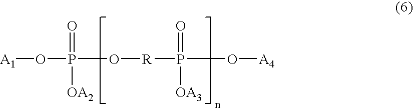
wherein n is an integer of 1 to 10; A₁ to A₄ are each independently a phenyl, tolyl or xylyl group, and when n is 2 or more, a plurality of A₃'s may be the same or different; and R is a group selected from the group consisting of the following formulas (R1) to (R4). 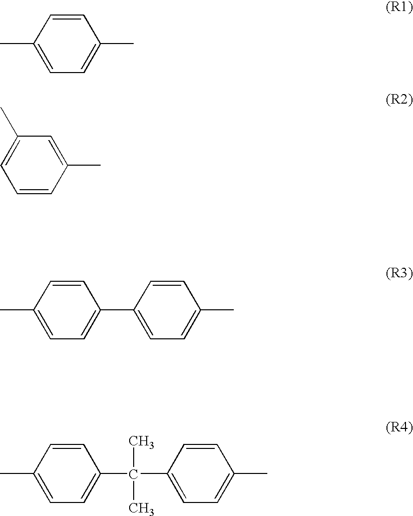
[17] The fire-retardant rubber modified styrenic resin composition according to any one of [1] to [16], wherein the component (A) is a rubber-modified polystyrenic resin, the content (a) of a rubber-like polymer in the rubber-modified polystyrenic resin is 3 to 15% by weight, the proportion (b) of solvent-insolubles in the rubber-modified polystyrenic resin is 10 to 30% by weight, the formula [(b)/(a)]≦3.5 is satisfied, and the swelling index of the rubber-modified polystyrenic resin in toluene is 9.0 to 11.5.
[18] The fire-retardant styrenic resin composition according to any one of [1] to [17], wherein the component (A) is a rubber-modified styrenic resin comprising a high cis polybutadiene containing the cis 1,4 bond in an amount of 90% by mole or more, and wherein the content (a) of a rubber-like polymer in the rubber-modified styrenic resin is 3 to 15% by weight, the proportion (b) of solvent-insolubles in the rubber-modified polystyrenic resin is 10 to 30% by weight, the formula 2.0≦[(b)/(a)]≦3.5 is satisfied, and the rubber-like polymer dispersed in the rubber-modified styrenic resin has an area-average particle size of 0.8 to 2.5 μm, the swelling index of the rubber-modified styrenic resin in toluene being 9.0 to 11.0.
[19] The fire-retardant styrenic resin composition according to any one of [1] to [18] which is used for internal parts of an electric/electronic device satisfying the UL 94 V-2 standard.
[20] The fire-retardant styrenic resin composition according to [19] which is used for the internal parts of an electric/electronic device satisfying the UL 94 V-2 standard and having an average thickness of 2 mm or less.
[21] The fire-retardant styrenic resin composition according to any one of [1] to [18] which is used for the external parts of an electric/electronic device satisfying the UL 94 V-2 standard.
[22] The fire-retardant styrenic resin composition according to [21] which is used for the external parts of an electric/electronic device satisfying the UL 94 V-2 standard and having an average thickness of 2 mm or less.
[23] The fire-retardant styrenic resin composition according to any one of [1] to [18] which is used for the external parts of an electric/electronic device satisfying the UL 94 V-0 standard.
[24] The fire-retardant styrenic resin composition according to any one of [1] to [18] which is used for the external parts of an electric/electronic device satisfying the UL 94 5V standard.

Incidentally, the wording “Residue after thermal weight loss by weight at 500° C.” described above is intended to mean the definition described later in the section which discusses [Analyzed values of the component (B): (a) Residue after thermal weight loss].

It is important for the present invention to have a fire retardant component of high char-producing capacity finely dispersed in the resin composition comprising the styrenic resin. Finely dispersing the styrenic resin with a fire retardant component adequately compatible with the resin and having a high char-producing capacity causes no deterioration of moldability of the composition and reduces the degradation of its heat resistance, unlike the case where the resin is incorporated with a large quantity of a polyphenylene ether. The fire retardant is considered to have an improved fire retarding effect when it has a melting point of 100 to 400° C., because the dispersed components charred while burning are connected to each other to uniformly cover the surface. It is also important for the present invention to finely disperse the fire retardant component of high char-producing capacity in such a way to have a ratio of its area-average particle size to that of the rubber-like polymer particles in the rubber-modified styrenic resin in a specific range.

The fire retardant component of high char-producing capacity can be dispersed in the resin composition more uniformly, when its molecular weight is kept at a relatively low level, and the dispersion conditions are controlled by an adequate kneading method or in the presence of a compatibilizer. The improved rigidity, fire retardancy and impact strength of the resin composition conceivably result from the above fact. Moreover, the resin composition can maintain its falling dart impact strength at a high level by controlling the respective particle sizes of the rubber-like polymer in the rubber-modified styrenic resin and finely dispersed fire retardant component to optimum ranges. It is considered that the positional relationship between a region in which crazes of the rubber-like polymer particles are produced while the resin composition is disintegrated and the location of the fire retardant component prevents the crazes from becoming cracks, although the mechanisms involved are not fully substantiated. It is also considered that the finely dispersed fire retardant component massively present in the vicinity of the resin composition surface reduces adhesion of the composition to a mold, improving its releasability. As a result, it is considered that the resin composition can be incorporated with a commonly used releasing agent at a lower content to have an improved balance between releasability and mold contamination resistance. The fire retardant component having an adequate melting point substantially melts during the kneading and/or molding step and later becomes fine spherical or oval particles, which are oriented to a flow direction near the surface. As a result, it is considered that this eliminates projections, which are observed in the surface area of common rubber particles or inorganic particles, and causes no adverse effects on the outer appearances of the product.

Incorporation of a limited quantity of polyphenylene ether substantially causes no deterioration of the moldability and prevents the reduction of heat resistance. The fire retardant component having a melting point in the above range allows the dispersed component to be charred while it is burnt to connect to each other, improving the effect of uniformly covering the surface. As a result, the self-extinguishing fire-retardant composition having a still improved self-extinguishing capacity when dripped can be produced.

To summarize: the present invention can provide a fire-retardant styrenic resin composition excellent in fire retardancy, of well-balanced physical properties of rigidity, heat resistance, fluidity for thin-wall products, falling dart impact strength and outer appearances, and which is also excellent in releasability and mold contamination resistance.

### BRIEF DESCRIPTION OF THE DRAWINGS

FIG. 1 is a transmission electron micrograph showing the particle structures of the rubber-like polymer and component (B), equivalent with those prepared in Example 2 described later, wherein [-] at the lower right corner corresponds to a length of 1 μm. The particles stained black in FIG. 1 represent the rubber-like polymer in the component (A), and outline holes represent the finely dispersed fire retardant component (B);

FIG. 2 is a transmission electron micrograph showing the particle structures of the rubber-like polymer and component (B), equivalent with those prepared in Example 4 described later, wherein [-] at the lower right corner corresponds to a length of 1 μm; and

FIG. 3 is a transmission electron micrograph showing the particle structures of the rubber-like polymer and component (B), equivalent with those prepared in Comparative Example 3 described later, wherein [-] at the lower right corner corresponds to a length of 1 μm.

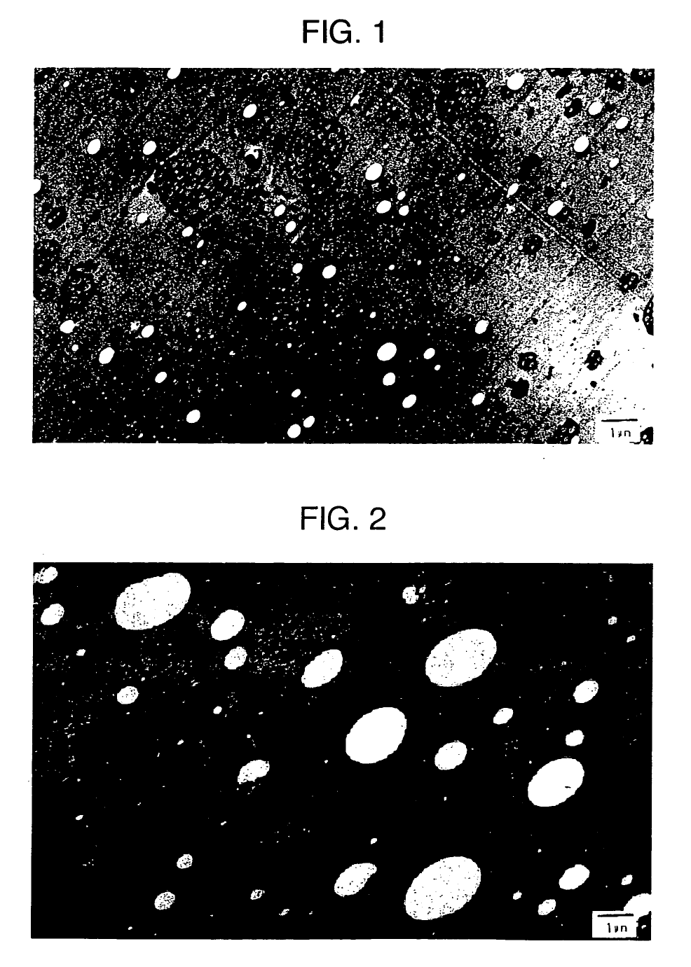

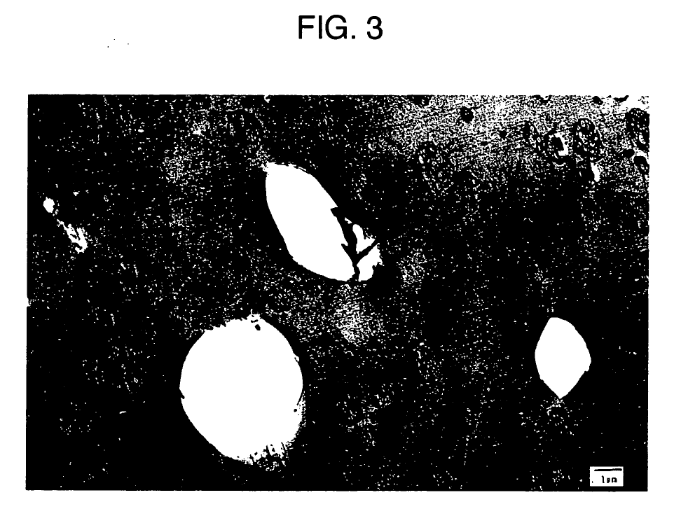

### BEST MODE FOR CARRYING OUT THE INVENTION

The present invention will now be described in more detail.

The “styrenic resin having a residue after thermal weight loss of below 20% at 500° C.” (hereinafter sometimes simply referred to as the component (A)) includes a styrenic resin which may be modified with rubber or not, and a blend of a styrenic resin which may be modified with rubber or not with another resin, although it is not limited thereto. A styrenic resin not modified with rubber can be produced by polymerizing a styrenic monomer. A rubber-modified styrenic resin, which is composed of a styrenic resin not modified with rubber as the matrix dispersed with rubber-like polymer particles, can be produced by polymerizing a styrenic monomer in the presence of a rubber-like polymer.

The styrenic monomers used for the present invention include, in addition to styrene, α-methyl styrene, α-methyl-p-methyl styrene, o-methyl styrene, m-methyl styrene, p-methyl styrene, vinyl toluene, ethyl styrene, isobutyl styrene, t-butyl styrene, bromostyrene, chlorostyrene and indene, of which styrene is more preferable. These styrenic monomers may be used either individually or in combination.

A styrenic monomer may be used together with another unsaturated monomer copolymerizable with the styrenic monomer, as required. The other unsaturated monomers copolymerizable with a styrenic monomer include unsaturated carboxylic acids, e.g., acrylic acid and methacrylic acid; alkyl esters of unsaturated carboxylic acids such as (meth)acrylic acid esters, e.g., methyl acrylate, ethyl acrylate, methyl methacrylate, ethyl methacrylate and butyl acrylate; and acrylonitrile, methacrylonitrile, maleic anhydride and phenyl maleimide. They may be used either alone or in combination. These unsaturated monomers copolymerizable with the styrenic monomer may be used in a combined amount of 50 wt % or less based on the total weight of the styrenic monomer and the unsaturated monomers.

The rubber-like polymers include polybutadiene, polyisoprene, natural rubber, polychloroprene, styrene/butadiene copolymer and acrylonitrile/butadiene copolymer, of which polybutadiene and styrene/butadiene copolymer are more preferable. A polybutadiene may be a high cis polybutadiene of high cis content or a low cis polybutadiene of low cis content. A styrene/butadiene copolymer may have a random or block structure. These rubber-like polymers may be used either individually or in combination. A butadiene rubber saturated with hydrogen is also useful for the present invention.

When a styrenic resin is a rubber-modified polystyrenic resin (high-impact polystyrene (HIPS)), a high cis polybutadiene containing the cis 1,4 bond in an amount of 90% by mole or more is especially preferable among these rubber-like polymers. The high cis polybutadiene improves the falling dart impact strength of the fire-retardant styrenic resin composition. The high cis polybutadiene preferably contains the vinyl 1,2 bond in an amount of 6% by mole or less, more preferably 3% by mole or less. The content of the one containing the cis 1,4, trans 1,4 or vinyl 1,2 bond as an isomer of high cis polybutadiene with respect to structural unit can be determined by infrared spectrophotometry and data-processed by the Morello method. The high cis polybutadiene can be easily produced by a known process, e.g., polymerization of 1,3-butadiene in the presence of a catalyst containing an organoaluminum compound and cobalt or nickel compound.

When a rubber-modified styrenic resin is an acrylonitrile/butadiene/styrene (ABS) resin containing acrylonitrile, the preferable ones include polybutadiene rubber, styrene/butadiene copolymer and acrylonitrile/butadiene copolymer rubber produced by emulsion polymerization, of which polybutadiene rubber is especially preferable. A rubber produced by emulsion polymerization is microstructurally a low cis polybutadiene of low cis content.

The content (a) of a rubber-like polymer in the styrenic resin is preferably 3 to 20% by weight, more preferably 3 to 15% by weight.

When the styrenic resin is a rubber-modified polystyrenic resin, in particular, the content of the rubber-like polymer is preferably 3 to 15% by weight, more preferably 4 to 10% by weight. At a content of the rubber-like polymer of below 3%, the resin composition may have a deteriorated impact strength. At above 15%, on the other hand, it may have a deteriorated rigidity. When the styrenic resin is an ABS resin, it is preferably 5 to 20% by weight, more preferably 10 to 15% by weight.

The rubber-like polymer particles are dispersed in the styrenic resin as the matrix. The rubber-like polymer particles preferably have an area-average particle size of 0.1 to 2.5 μm. When the styrenic resin is a rubber-modified polystyrenic resin, in particular, the area-average particle size is preferably 0.3 to 2.5 μm, more preferably 0.8 to 2.5 μm. When the area-average particle size is below 0.3 μm, the resin composition may have a deteriorated impact strength. When it is above 2.5 μm, on the other hand, the resin composition may have deteriorated outer appearances, rigidity and fire retardancy. When the styrenic resin is an ABS resin, the area-average particle size is particularly preferably 0.1 to 0.4 μm. When the area-average particle size is below 0.1 μm, the resin composition may have a deteriorated impact strength. When it is above 0.4 μm, on the other hand, the resin composition may have deteriorated outer appearances, rigidity and fire retardancy.

The proportion (b) of solvent-insolubles in the rubber-modified styrenic resin is preferably 10 to 30% by weight with a mixed solvent of methyl ethyl ketone/methanol, more preferably 15 to 26% by weight. At a proportion (b) below 10% by weight, the resin composition may have a deteriorated impact strength. At above 30%, on the other hand, the resin composition may have a deteriorated rigidity. When the styrenic resin is an ABS resin, it is preferably 10 to 26% by weight with acetone as the solvent, more preferably 15 to 20% by weight. The wording “the proportion (b) of solvent-insolubles in the rubber-modified styrenic resin” described above is intended to mean the definition described later in the section which discusses [Analyzed values of the component (A): (3) Proportion of solvent-insolubles, defined as gel content].

The content (a) of the rubber-like polymer in the rubber-modified styrenic resin and the proportion (b) of solvent-insolubles in the rubber-modified styrenic resin preferably satisfy the relationship

[(b)/(a)]≦3.5 for impact strength of the resin composition, more preferably 2.0≦[(b)/(a)]≦3.5.

The rubber-modified styrenic resin preferably has a swelling index of 9.0 to 11.5 in toluene, more preferably 9.0 to 10.5. At below 9.0, the resin composition may have a deteriorated impact strength. At above 11.5, on the other hand, the resin composition may have deteriorated falling dart impact strength and its retention, gloss and its retention and rigidity.

The wording “the swelling index of the rubber-modified polystyrenic resin in toluene” described above is intended to mean the definition described later in the section which discusses [Analyzed values of the component (A): (6) Swelling index of the rubber-modified polystyrenic resin in toluene].

When the styrenic resin used as the component (A) for the present invention is a rubber-modified styrenic resin, the value ranges for the best balanced physical properties of impact strength and fluidity of the resin composition are as follows attributable to the combination of the above-described effects; the content (a) of the rubber-like polymer in the rubber-modified styrenic resin is 3 to 20% by weight; the proportion (b) of solvent-insolubles in the rubber-modified styrenic resin is 10 to 30% by weight; [(b)/(a)]≦3.5; the area-average particle size of the rubber-like polymer dispersed in the rubber-modified styrenic resin is 0.1 to 2.5 μm; and the swelling index of the rubber-modified styrenic resin in toluene is 9.0 to 11.5.

When the rubber-modified styrenic resin is a rubber-modified polystyrenic resin, the value ranges for the best balanced impact strength and fluidity of the resin composition attributable to the above-described effects are as follows; the content (a) of the rubber-like polymer in the rubber-modified styrenic resin is 3 to 15% by weight; the proportion (b) of solvent-insolubles in the rubber-modified polystyrenic resin is 10 to 30% by weight; [(b)/(a)]≦3.5; the area-average particle size of the rubber-like polymer dispersed in the rubber-modified polystyrenic resin is 0.3 to 2.5 μm; and the swelling index of the rubber-modified polystyrenic resin in toluene is 9.0 to 11.5. More preferably the content (a) of the rubber-like polymer in the rubber-modified polystyrenic resin is 4 to 10% by weight; the proportion (b) of solvent-insolubles in the rubber-modified polystyrenic resin is 15 to 26% by weight; 2.0≦[(b)/(a)]≦3.5; the area-average particle size of the rubber-like polymer dispersed in the rubber-modified polystyrenic resin is 0.8 to 2.5 μm; and the swelling index of the rubber-modified polystyrenic resin in toluene is 9.0 to 10.5.

When the rubber-modified styrenic resin is an ABS resin, the value ranges for the best balanced impact strength and fluidity of the resin composition are the content (a) of the rubber-like polymer in the ABS resin is 5 to 20% by weight; the proportion (b) of solvent-insolubles in the ABS resin is 10 to 26% by weight; [(b)/(a)]≦2.0; and the area-average particle size of the rubber-like polymer dispersed in the ABS resin is 0.1 to 0.4 μm.

The styrenic resin as the component (A) for the present invention preferably has a molecular weight of 0.4 to 0.8 dL/g in terms of reduced viscosity, more preferably 0.45 to 0.7 dL/g. Reduced viscosity is determined under the measurement conditions of 30° C. and a concentration of 0.5 g/dL in a toluene solution for a polystyrenic resin, and 30° C. and a concentration of 0.5 g/dL in a methyl ethyl ketone solution for an unsaturated nitrile/styrene copolymer.

The process for producing a rubber-modified styrenic resin is not limited to any particular process. It can be produced by bulk (or solution) polymerization of a styrenic monomer (and solvent) in the presence of a rubber-like polymer. It may be also produced by bulk-suspension polymerization, which starts with bulk polymerization which is replaced with suspension polymerization halfway through the procedure, or by emulsion graft polymerization of a styrenic monomer in the presence of a rubber-like polymer latex. In bulk polymerization, a mixed solution of a rubber-like polymer, styrenic monomer, and optionally an organic solvent, an organic peroxide and a chain transfer agent is continuously supplied to a polymerization system comprising a complete-mixing reactor or tank reactor connected to a series of tank reactors.

The process for producing a blend of the styrenic resin as the component (A) for the present invention and another resin is not limited. The common methods include melting and kneading in a single-screw, special single-screw or twin-screw extruder, and melting the other resin in the styrenic resin polymerization step.

A blend of a rubber-modified polystyrenic resin and polyphenylene ether is one of the preferable blends of a styrenic resin and another resin for the present invention. The polyphenylene ethers used for the present invention include poly(2,6-dimethyl-1,4-phenylene ether), and a copolymer of poly(2,6-dimethyl phenol) and 2,3,6-trimethyl phenol. The process for producing a polyphenylene ether is not limited. It can be produced by, e.g., oxidative polymerization of 2,6-xylenol. The polyphenylene ether has a molecular weight of 0.2 to 0.7 dL/g in terms of reduced viscosity, more preferably 0.3 to 0.6 dL/g. Reduced viscosity is determined under the measurement conditions of 30° C. and a concentration of 0.5 g/dL in a chloroform solution.

The rubber-modified styrenic resin is incorporated preferably at 70% by weight or more of the whole blend, more preferably 80% by weight or more. The amount of the rubber-modified styrenic resin of below 70% is not desirable because of a deterioration of fluidity of the resin composition. When the fire-retardant styrenic resin composition is required to pass the UL's V-2 standard, in particular, the polyphenylene ether is incorporated preferably at 0 to 8 parts by weight per 100 parts by weight of the rubber-modified styrenic resin. Moreover, when the resin composition is required to have a self-extinguishing capacity when dripped and a high falling dart impact strength, the polyphenylene ether is incorporated preferably at 0.1 to 8 parts by weight. At the incorporation of below 0.1 parts by weight, the resin composition may have a deteriorated self-extinguishing capacity when dripped. At above 8 parts, on the other hand, the resin composition may have a deteriorated fluidity for thin-wall products.

When the fire-retardant styrenic resin composition is required to pass the UL's V-1 standard or higher, the polyphenylene ether is incorporated preferably at 10 to 40% by weight based on the whole blend, more preferably 15 to 30% by weight. At below 10% by weight, the resin composition may be difficult to satisfy fire retardancy of the V-1 standard or higher.

It is essential for the present invention that the halogen compound-free, fire retardant component (Component (B)) is dispersed in particulate form in the component (A) and that the dispersed particles of the component (B) have an area-average particle size of 0.01 to 3 μm, more preferably 0.04 to 3 μm, still more preferably 0.05 to 1 μm. The resin composition has deteriorated fire retardancy and impact strength when the area-average particle size of the component (B) is above 3 μm, and has a deteriorated heat resistance when it is below 0.01 μm.

Moreover, the resin composition can have a still more greatly improved falling dart impact strength, when the relationship between an area-average particle size (Dr) of the rubber-like polymer dispersed in the component (A) and an area-average particle size (Df) of the component (B) satisfies the following formula:
0.01≦(Df/Dr)≦1.0 (1)
(wherein, Df is an area-average particle size of the component (B), and Dr is an area-average particle size of the rubber-like polymer in the component (A)).

The (Df/Dr) ratio is more preferably 0.04 or more and 1.0 or less, still more preferably 0.06 or more and 0.5 or less. The resin composition tends to have deteriorated falling dart impact strength and heat resistance when the ratio is below 0.01. The resin composition has a deteriorated retention of falling dart impact strength, in particular as compared with that of the base resin, and deteriorated balance of physical properties among rigidity, outer appearances and fire retardancy when the ratio is above 1.0.

For the fire-retardant styrenic resin composition required to pass the UL's V-2 standard, the (Df/Dr) ratio is preferably 0.04 or more and 1.0 or less. In the V-2 fire-retardant composition, incorporated with a small quantity of polyphenylene ether to improve the self-extinguishing capacity when dripped, the (Df/Dr) ratio is preferably 0.01 or more and 1.0 or less. The difference between these compositions in the preferable (Df/Dr) ratio range conceivably results from a changed compatibility of the fire retardant component by the incorporation of a polyphenylene ether.

The component (B) preferably has a residue after thermal weight loss of 20% or more at 500° C., more preferably 30% or more. The resin composition may have a deteriorated fire retardancy when the residue after thermal weight loss is below 20%. Moreover, the component (B) preferably has a melting point of 100 to 400° C., more preferably 100 to 300° C. The resin composition may have a deteriorated heat resistance when the melting point is below 100° C., and deteriorated falling dart impact strength and outer appearances when it is above 400° C. Still more, the component (B) preferably has a molecular weight of 200 to 2000. The resin composition tends to cause contamination of a mold when the molecular weight is below 200, and may have deteriorated releasability and fluidity when it is above 2000.

The component (B) is not limited, so long as it satisfies the above requirements. For example, the phosphorus-based fire retardants include those represented by the formulas (4) and (5): 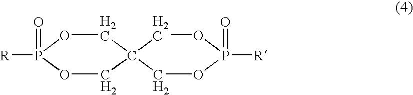
(wherein, R and R′ are each an alkyl group of 1 to 12 carbon atoms, cycloalkyl group of 5 to 10 carbon atoms, aralkyl group of 7 to 20 carbon atoms or aryl group of 6 to 15 carbon atoms, and may be the same or different), and 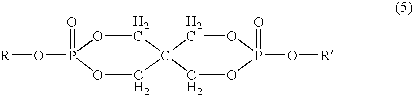
(wherein, R and R′ are each an alkyl group of 1 to 12 carbon atoms, cycloalkyl group of 5 to 10 carbon atoms, aralkyl group of 7 to 20 carbon atoms or aryl group of 6 to 15 carbon atoms, and may be the same or different).

The examples of R and R′ in the formulas (4) and (5) include alkyl groups of 1 to 12 carbon atoms, e.g., methyl, ethyl, propyl, isopropyl, n-butyl, t-butyl and neopentyl; cycloalkyl groups of 5 to 10 carbon atoms, e.g., cyclohexyl and cyclooctyl; aralkyl groups of 7 to 20 carbon atoms, e.g., benzyl, phenethyl, phenylpropyl, naphthylmethyl and 2-phenylisopropyl; and aryl groups of 6 to 15 carbon atoms, e.g., phenyl, naphthyl, anthranyl, xylyl, trimethylphenyl di-t-butylphenyl, and di-t-butylphenyl.

Of these, the phosphorus-based fire retardants represented by the formula 4 are particularly preferable. More preferable ones are those having R and R′ each of methyl, ethyl, propyl, isopropyl, n-butyl, t-butyl, cyclohexyl, benzyl, phenethyl, phenylpropyl or 2-phenylisopropyl, more preferably benzyl or phenethyl, still more preferably benzyl in consideration of its adequate compatibility with the other component and fire retardancy of the resin composition.

The process for producing the fire retardant represented by the formula (4) generally comprises reacting an adjacent diol skeleton with e.g., the alkyl, cycloalkyl, aralkyl or aryl phosphoric acid dichloride corresponding to R or R′. These reactions are disclosed by JP-A-54-157156 and JP-A-53-39698. More specifically, they can be produced by reacting pentaerythritol with methyl phosphoric acid dichloride, phenyl phosphoric acid dichloride, benzyl phosphoric acid dichloride or the like.

The process for producing the fire retardant represented by the formula (5) generally comprises reacting an adjacent diol skeleton with phosphorus oxytrichloride and then with the phenolic hydroxyl group or the like corresponding to R or R′. For example, these reactions are disclosed by JP-A-9-183786 and J. Org. Chem., vol. 24, p. 630 to 635 (1959). More specifically, they can be produced by reacting pentaerythritol with phosphorus oxytrichloride and then with phenol, 2,6-dimethyl phenol, cresol or the like.

The fire-retardant resin composition of the present invention can have still better balanced fire retardancy and mechanical physical properties, when it comprises an auxiliary fire retardant as the component (C), in addition to the essential components (A) and (B). The fire retardant as the component (C) may be a phosphorus-based fire retardant, an inorganic fire retardant or a silicon-based fire retardant other than the component (B), although not limited thereto. The phosphorus-based fire retardants include organic phosphorus, red phosphorus and inorganic phosphorus compounds. The organic phosphorus compounds include phosphine, phosphine oxide, biphosphine, phosphonium salt, phosphinate, phosphoric acid ester and phosphorous acid ester. More specifically, they include phosphoric acid esters, e.g., trimethyl phosphate, triethyl phosphate, tripropyl phosphate, tributyl phosphate, tripentyl phosphate, trihexyl phosphate, tricyclohexyl phosphate, triphenyl phosphate, tricresyl phosphate, trixylenyl phosphate, dimethylethyl phosphate, methyldibutyl phosphate, ethyldipropyl phosphate, hydroxyphenyldiphenyl phosphate and trisnonylphenyl phosphate; and methylneopentyl phosphite, pentaerythritol diethyl diphosphite, dineopentyl hypophosphite and phenyl pyrocatechol phosphite.

The fire retardants of condensed phosphoric acid esters include the compounds represented by the formula (6). More specifically, those represented by the formula (6) include bisphenol A bis(diphenyl phosphate), bisphenol A bis(di-2,6-dixylenyl phosphate), bisphenol A bis(dicresyl phosphate), resorcinol bis(diphenyl phosphate) and resorcinol bis(di-2,6-dixylenyl phosphate). 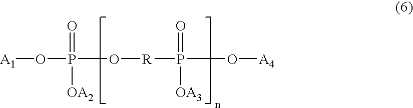
(wherein, “n” is an integer of 1 to 10; A₁ to A₄ are each independently a phenyl, tolyl or xylyl group, and A₃s may be the same or different, when “n” is 2 or more; and R is a group selected from the group consisting of the following formulas (R1) to (R4).

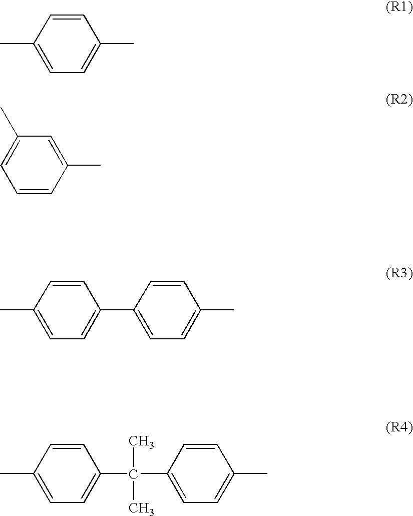

The red phosphorus may be common red phosphorus itself. In addition, it is suitable that the surface of red phosphorous may be coated beforehand; with a metal hydroxide selected from the group consisting of aluminum hydroxide, magnesium hydroxide, zinc hydroxide and titanium hydroxide; with a mixture of a metal hydroxide and a thermosetting resin, the former being selected from the group consisting of aluminum hydroxide, magnesium hydroxide, zinc hydroxide and titanium hydroxide; or with a metal hydroxide selected from the group consisting of aluminum hydroxide, magnesium hydroxide, zinc hydroxide and titanium hydroxide and then with a thermosetting resin on the metal hydroxide liquid coating to form a double coating layer.

A typical example of the inorganic phosphorus compounds used for the present invention is an ammonium polyphosphate.

These phosphorus-based fire retardants may be used either individually or in combination.

The inorganic fire retardants include aluminum hydroxide, magnesium hydroxide, dolomite, hydrotalcite, calcium hydroxide, barium hydroxide, basic magnesium carbonate, zirconium hydroxide, hydrates of inorganic metallic compounds such as a hydrate of tin oxide, zinc borate, zinc metaborate, barium metaborate, zinc carbonate, magnesium carbonate, moo-calcium, calcium carbonate, barium carbonate, magnesium oxide, molybdenum oxide, zirconium oxide, tin oxide and antimony oxide. They may be used either individually or in combination. Of these, the inorganic fire retardant is preferably selected from the group consisting of magnesium hydroxide, aluminum hydroxide, basic magnesium carbonate and hydrotalcite.

The silicon-based fire retardants include compounds containing RSiO, where R is, for example, an aryl group such as a phenyl or xylyl group, an alkyl group such as a methyl or propyl group, an alkenyl group or the like. Polyorganosiloxanes are common silicon-based fire retardants.

The particularly preferable compounds among the halogen compound-free fire-retardant component (C) are the condensed phosphoric acid esters represented by the formula (6). The particularly preferable compounds are bisphenol A bis(diphenyl phosphate), bisphenol A bis(di-2,6-dixylenyl phosphate), resorcinol bis(diphenyl phosphate) and resorcinol bis(di-2,6-dixylenyl phosphate).

It is essential in the present invention to control the dispersed particle sizes of the rubber-like polymer particles in the component (A) and fire retardant particles as the component (B), respectively, and also to keep a given relationship between these dispersed particle sizes (i.e., to keep a predetermined ratio of area-average particle sizes).

A known process can be employed for controlling the particle size of the rubber-like polymer particles in the rubber-modified styrenic resin as the component (A). When the rubber-modified styrenic resin is produced by bulk (or solution) polymerization or bulk-suspension polymerization, the rubber-like polymer particles can be controlled to have a size in a desired range by controlling the viscosity in the system or agitation speed in the reactor, use of an adequate initiator for the graft reaction, or a combination thereof while the rubber-like polymer particles are being produced by phase inversion as the polymerization process proceeds. When the rubber-modified styrenic resin is produced by emulsion graft polymerization of a styrenic monomer in the presence of a rubber-like polymer latex, the rubber-like polymer particle size can be controlled by the initial particle size of the rubber-like latex.

The rubber-like polymer particle size can be controlled to have a near monodisperse, broad particle size distribution or two-peak distribution form. Among them, the broad particle size distribution and two-peak distribution are more preferable for improving the falling dart impact strength.

How the fire retardant particles as the component (B) are dispersed is very important in order for the resin composition to have an improved falling dart impact strength in connection with how the rubber-like polymer particles are dispersed in the rubber-modified styrenic resin as the component (A), and also important by itself for the resin composition in order to maintain good fire retardancy when dripped, rigidity and outer appearances. In other words, the fire retardant particles as the component (B) must be finely dispersed more adequately. The component (B) can be controlled to have a desired dispersed particle size by kneading and/or use of a compatibilizer. When a kneading process is employed, the dispersed particle size of the component (B) can be controlled and finely dispersed to a desired range by use of a twin-screw extruder or by shearing in the kneader at a kneading temperature close to the melting point of the component (B) or the like.

The component (B) can be also controlled to have a dispersed particle size in the presence of a compatibilizer as the component (D). The compatibilizer is preferably a polymer (homopolymer or copolymer) component having a structural unit with a polar group as an essential unit. The polymer (homopolymer or copolymer) component having a structural unit with a polar group as an essential unit may be (meth)acrylic acid, alkyl ester of (meth)acrylic acid, (meth)acrylonitrile, maleic anhydride, N-phenyl maleimide, or one having an epoxy or amide group. The compatibilizer may be used independently or as a copolymer of 2 or more monomers. It may also be a copolymer with a nonpolar unit, e.g., a styrenic unit.

Of these, the more preferable ones are a polymer comprising a unit of alkyl ester of (meth)acrylic acid, copolymer of the above unit and styrene, and copolymer of acrylonitrile and styrene. The preferable polymers comprising a unit of alkyl ester of (meth)acrylic acid include homopolymers and copolymers of butyl acrylate, methyl methacrylate or 2-ethylhexyl acrylate, and a copolymer with styrene. The acrylonitrile/styrene copolymer preferably has a styrene/acrylonitrile compositional ratio (by weight) in a broad range of 100/1 to 100/30, and an average acrylonitrile content of 5 to 20% by weight for its compatibility with the other components. In the copolymer, the polar component may be bound to polystyrene by block or graft polymerization.

The component (D) preferably has a weight-average molecular weight of 1,000 to 50,000.

The resin composition is preferably incorporated with the component (B) in an amount of 0.5 to 50 parts by weight per 100 parts by weight of the component (A), more preferably in an amount of 2 to 30 parts by weight. The resin composition has a deteriorated fire retardancy when the content of the component (B) is below 0.5 parts by weight, and a deteriorated impact strength when it is above 50 parts by weight. The component (C), when used, is preferably incorporated at 0.1 to 40 parts by weight. The content of the component (C) in the resin composition preferably does not exceed that of the component (B).

The fire-retardant styrenic resin composition, when required to pass the UL's V-2 standard, is preferably incorporated with the component (B) at 0.5 to 10 parts by weight per 100 parts by weight of the component (A), more preferably 1 to 7 parts by weight. The resin composition has a deteriorated fire retardancy of the dripped composition when the content of the component (B) is below 0.5 parts by weight, and the resin composition has deteriorated impact strength, outer appearances and fire retardancy of the dripped composition when it is above 10 parts by weight. The component (C), when used, is preferably incorporated at 0.1 to 10 parts by weight, more preferably 1 to 7 parts.

When the resin composition is required to pass the UL's V-2 standard which specifies a higher self-extinguishing capacity of the dripped composition, the resin composition is preferably incorporated with a polyphenylene ether at 0.1 to 8 parts by weight and the component (B) at 0.5 to 10 parts by weight per 100 parts by weight of the rubber-modified polystyrenic resin as the component (A), more preferably 0.5 to 5 parts by weight for the polyphenylene ether and 1 to 7 parts by weight for the component (B). The resin composition has a deteriorated self-extinguishing capacity of the dripped composition and falling dart impact strength when the content of polyphenylene ether is below 0.1 parts by weight, and the resin composition has a deteriorated fluidity for thin-wall products when it is above 8 parts by weight. The resin composition has a deteriorated fire retardancy of the dripped composition when the content of component (B) is below 0.5 parts by weight, and the resin composition tends to have a deteriorated falling dart impact strength when it is above 10 parts by weight. The component (C), when used, is preferably incorporated at 0.1 to 8 parts by weight, more preferably 1 to 6 parts. The resin composition may show no improvement in fire retardancy when the content of the component (C) is below 0.1 parts by weight, and may have a deteriorated impact strength when it is above 8 parts by weight.

When the resin composition is required to pass the UL's V-1 standard or higher, which specifies higher fire retardancy, the resin composition is incorporated with a blend of the rubber-modified polystyrenic resin as the component (A) and a polyphenylene ether, the polyphenylene ether being incorporated at 10 to 40% by weight based on the whole blend, more preferably 15 to 30% by weight, and the component (B) being incorporated preferably at 5 to 20 parts by weight per 100 parts by weight of the whole blend, more preferably 10 to 15 parts by weight. It is difficult for the resin composition to exhibit sufficient fire retardancy in order to pass the V-1 standard or higher when the content of polyphenylene ether is below 10% by weight, and the resin composition has a deteriorated fluidity when it is above 40% by weight. The resin composition has a deteriorated fire retardancy when the content of component (B) is below 5 parts by weight, and the resin composition tends to have a deteriorated falling dart impact strength when it is above 20 parts by weight. The component (C), when used, is preferably incorporated at 2 to 20 parts by weight, more preferably 5 to 15 parts by weight. The resin composition shows no improvement in fire retardancy when the content of the component (C) is below 2 parts by weight, and the resin composition has deteriorated impact strength and heat resistance when it is above 20 parts by weight.

The resin composition with the component (A) incorporated with a polyphenylene ether preferably satisfies the relationship 0.4≦(Y/X)≦2.0 for balanced physical properties of fire retardancy, impact strength and fluidity of the resin composition (in particular for thin-wall products), wherein X is the incorporated part of polyphenylene ether and Y is the incorporated part of component (B). The resin composition tends to have a deteriorated fluidity for thin-wall products when the (Y/X) ratio is below 0.4, and the resin composition tends to have a deteriorated impact resistance when it is above 2.0.

The process for producing the fire-retardant styrenic resin composition of the present invention is not limited. The blend of the components (A) and (B), and an optional component (C), may be molten and kneaded in a twin-screw extruder. The component (C) may be optionally added as a side feed to a blend of the components (A) and (B) while melt-kneading in a twin-screw extruder. Similarly, the component (B), and component (C) as required, may be added as a side feed to the component (A) while melt-kneading the component (A) in a twin-screw extruder. The component (A) and a part of the component (B) is blended followed by adding the rest of the component (B), and component (C) as required, as a side feed while melt-kneading in a twin-screw extruder.

Moreover, in the production process of the rubber-modified styrenic resin, the polyphenylene ether, the component (B) and/or the component (C) may be directly supplied to the first reactor or they may be injected through the line connecting one reactor to another, or they may be injected through the line from the final reactor to the pelletizer.

The rubber-modified styrenic resin composition of the present invention may be further incorporated with one or more additives, as required, e.g., silicon oil, mineral oil, plasticizer, lubricant or antioxidant at an optional position in the polymerization system or while melt-kneading by using an extruder within limits not harmful to the effect of the present invention.

### REFERENCE EXAMPLES 1 TO 13, EXAMPLES 1 TO 65, AND COMPARATIVE EXAMPLES 1 TO 20

The present invention is described in more detail by Reference Examples, Examples and Comparative Examples, where “parts” are by weight in all cases, and “%” is also by weight unless otherwise stated. It should be understood that the present invention is by no means limited by the Examples.

The following analytical and evaluation procedures of physical properties were employed in the Examples or the like.

Analyzed Values of the Component (A)

(1) Content (%) of the Cis 1,4 Bond in the Rubber-Like Polymer

The content was determined by infrared spectrophotometry and data-processed by the Morello method.

(2) Content (%) of the Rubber-Like Polymer in the Styrenic Resin (Defined as Rubber Content)

The content of the rubber-like polymer was determined from the amount of the butadiene segment, found by pyrolysis gas chromatography while taking into consideration the bonding mode of the butadiene segment.

(3) Proportion (%) of Solvent-Insolubles (Defined as Gel Content)

To about 1 g of a weighed rubber-modified styrenic resin (W) was added 20 mL of a mixed solvent of methyl ethyl ketone/methanol (ratio of 90/10 by weight) when the resin was a rubber-modified polystyrene resin or 20 mL of acetone when the resin was an ABS resin, and the mixture was shaken in a shaker for 60 minutes to dissolve the resin. The solution was then treated by a centrifugal separator (himacCR20 equipped with an R20A2 rotor, Hitachi, Ltd.) at 0° C. and 20,000 rpm for 60 minutes. The supernatant liquor was removed by decantation, and the precipitates (solvent-insolubles) were accurately weighed (Wc). The gel content was determined by the following formula.
Gel content (b)=Wc/W×100
(4) Ratio of Gel Content to Rubber Content

The gel content/rubber content ratio was determined using the rubber content (a) determined in the above (2) and the gel content (b) determined in the above (3) by the following formula.
Ratio of gel content to rubber content=[(b)/(a)]
(5) Area-Average Particle Size of the Rubber-Like Polymer

A 75 nm thick superthin specimen of the fire-retardant, rubber-modified styrenic resin composition, stained with osmium tetraoxide, was made and photographed by an electron microscope at a magnification of 10,000 (see FIG. 1)). In the micrograph, the black-stained particles represent the rubber-like polymer in the component (A). The particle size was measured for each of the rubber-like polymer particles in the component (A), shown in FIG. 1, and the area-average particle size was determined by the following formula (N1):
Area-average particle size=ΣniDri³/ΣniDri² (N1)
(wherein, ni: number of the rubber-like polymer particles, shown in the micrograph, having a particle size of Dri, and the particle size Dri: circle-equivalent particle size, determined from the area of each particle shown in the micrograph).

In the measurement, the micrograph was set in a scanner (resolution: 200 dpi) and image-processed by a particle analysis software for an image analyzer (IP-1000, Asahi Kasei Corporation).

(6) Swelling Index of the Rubber-Modified Styrenic Resin in Toluene

About 1 g of the rubber-modified styrenic resin was dissolved in 20 mL of toluene in a precipitating tube for centrifugal separation with shaking in a shaker for 60 minutes. The solution was then treated by a centrifugal separator (himacCR20 equipped with an R20A2 rotor, Hitachi, Ltd.) at 0° C. and 20,000 rpm for 60 minutes. The supernatant liquor was removed by decantation, and the swollen toluene-insolubles were accurately weighed (Ws). Next, the swollen toluene-insolubles were dried at 130° C. for 1 hour under normal pressure and then under a vacuum for 30 minutes in a vacuum drier. The dried toluene-insolubles were accurately weighed (Wd). Swelling index was determined by the following formula.
Swelling index=Ws/Wd
(7) Reduced Viscosity

Reduced viscosity can be used as an index for molecular weight of the styrenic resin. The supernatant liquor, produced by the centrifugal separation in the above (3), was incorporated with methanol to precipitate the styrenic resin, which was separated by filtration and dried to prepare the sample. It was dissolved in toluene at 0.5 g/dL and 30° C. and the measurement was conducted.

Analyzed Values of the Component (B)

(a) Residue after Thermal Weight Loss

Residue after thermal weight loss, used as an index for char-producing capacity, was determined by thermogravimetric analysis (TGA). The sample was heated at 10° C./minute in a thermogravimetric analyzer (TGA-50, Shimadzu Corporation) in a flow of nitrogen (flow rate: 20 mL/minute) to 500° C. The residue (%) at 500° C. was defined as residue after thermal weight loss (%).

(b) Melting Point

Melting point was determined by differential scanning calorimetry (DSC). The sample was heated in a heat flux differential scanning calorimeter (DSC-50, Shimadzu Corporation) at 10° C./minute in a flow of nitrogen (flow rate: 20 mL/minute), where the intersection point of the lines tangential to the baseline and endothermic peak rise-up portion was defined as the melting point.

(c) Area-Average Particle Size

A 75 nm thick superthin specimen of the fire-retardant, rubber-modified styrenic resin composition, stained with osmium tetraoxide, was made and photographed by an electron microscope at a magnification of 10,000 (see FIG. 1). In the micrograph, the black-stained particles represent the rubber-like polymer in the component (A), and the gray-stained particles and outline holes represent the component (B). Some of the component (B) particles may be eliminated from the superthin specimen while it is made, and such an elimination produces the outline holes. Therefore, the component (B) particles to be measured are the gray-stained particles and outline holes. The particle size was measured for each of the component (B) particles, shown in the micrograph, and the area-average particle size was determined by the following formula (N2):
Area-average particle size=ΣniDfi³/ΣniDfi² (N2)
(wherein, ni: number of the component (B) particles, shown in the micrograph, having a particle size of Dfi, and the particle size Dfi: circle-equivalent particle size, determined from the area of each particle shown in the micrograph).

In the analysis, the micrograph was set in a scanner (resolution: 200 dpi) and image-processed by a particle analysis software for an image analyzer (IP-1000, Asahi Kasei Corporation).

<Procedures for Evaluating Physical Properties of the Fire-Retardant Rubber-Modified Styrenic Resin Composition>

The procedures for evaluating physical properties are described below. Rigidity is evaluated by flexural modulus, impact strength by Charpy impact strength and falling dart impact strength, heat resistance by thermal deformation temperature, fluidity by melt flow rate, and outer appearances by gloss and its retention.

(1) Charpy Impact Strength

The resin composition was pelletized by a molding machine (J100E-P, The Japan Steel Works, Ltd.) under the conditions of cylinder temperature: 220° C. and mold temperature: 45° C. in accordance with ISO294-1. The test was carried out in accordance with ISO179.

(2) Falling Dart Impact Strength and its Retention

The specimen, 70 mm by 150 mm by 2 mm (thickness) in size, was prepared by a molder (IS-55EPN, Toshiba Machine Co., Ltd.) operated under the conditions of mold temperature: 45° C. and cylinder temperature: 220° C. The test was carried out by a Du Pont type dart impact tester (Toyo Seiki Seisaku-Sho, Ltd.) (impact core receiver: 9.4 mm in diameter, impact core: 6.2 mm in tip diameter, and load: 1 kg), where a missile was dropped onto the specimen center to determine fracture energy from the load at which the specimen was 50% fractured, which was defined as falling dart impact strength. Its measurable upper limit was 100 kg·cm. Falling dart impact strength retention was defined as the retention (%) of falling dart impact strength of the composition of the component (A) and the fire-retardant component (B) relative to that of the standard composition of the component (A) alone.

(3) Flexural Modulus

Flexural modulus was determined in accordance with ISO 178.

(4) Thermal Deformation Temperature

Thermal deformation temperature was determined in accordance with ISO 75-2 using the ISO specimen prepared in the above (1).

(5) Melt Flow Rate

Melt flow rate was determined at 200° C. in accordance with ISO 1133.

(6) Spiral Flow

Spiral flow can be used as an index for fluidity for thin-wall products. Spiral flow was defined as a spiral length of the injection-molded specimen prepared by an injection molder (J100E-P, The Japan Steel Works, Ltd.) with a mold having 2 mm thick spiral cavities, under the conditions of temperature: 220° C., mold temperature: 40° C. and injection pressure: 770 kg/cm².

(7) Gloss and its Retention

Gloss of the ISO specimen prepared in the above (1) was measured with the fluid terminal at a 60° angle in accordance with JIS K7015.

Gloss retention was defined as the retention (%) of gloss of the specimen of the composition of the component (A) and the fire-retardant component (B) relative to that of the standard composition of the component (A) alone.

(8) Releasability

Releasability was evaluated by extent of scars of the injection-molded article, which were generated depending on the magnitude of resistance to releasing within the injection-molded article, while it was released from a mold. More specifically, a 2 mm thick, 50 mm longitudinal, 90 mm transversal and 40 mm deep, box-shape molded article having two pieces of ribs 1 mm thick arranged to be 30 mm apart in the side locations, is used. The injection molding was carried out using a molder (J100E-P, The Japan Steel Works, Ltd.) under the conditions of temperature: 220° C. and mold temperature: 45° C. Releasability was evaluated by extent of scars generated in the injection-molded article when released according to the following standards. The evaluation was conducted by using the specimen stained black to facilitate visual observation of the scars.

⊚ No scar is observed.

◯ Spot-shaped scars are observed, although slightly, at the corners in the molded article.

Δ Line-shaped scars, 2 mm long or less, are observed, although slightly, at the corners in the molded article.

x Line-shaped scars, longer than 2 mm, are observed at the corners in the molded article.

(9) Test for Mold Contamination Resistance

Plates, 50 mm by 100 mm by 2.5 mm in size, were continuously prepared by using a molder (IS-55EPN, Toshiba Machine Co., Ltd.) under the conditions of mold temperature: 45° C. and cylinder temperature: 220° C. The mold after completing 1,000 shots of molding was visually observed to evaluate mold contamination resistance according to the following standards.

◯ No deposit is observed on the mold wall.

Δ White solids or transparent deposits are observed, although slightly.

x White solids or transparent deposits are massively observed.

(10) Fire Retardancy and Self-Extinguishing Capacity when Dripped

A specimen strip, 3.0 mm and 1.5 mm in size, was tested for fire retardancy (UL94 fire retardancy) in accordance with the 94V-2 (hereinafter simply referred to as V-2) specified in “UL 94 Safety Standards: Tests for Flammability of Plastic Materials for Parts in Devices and Appliances, Clauses 7 to 10” published by Underwriters Laboratories Inc. in the United States.

Self-extinguishing capacity of the dripped resin composition was evaluated by the time required by a burning drop once contacting a flame to extinguish by itself after it was dripped during the V-2 testing. Self-extinguishing capacity when dripped was evaluated by the self-extinguishing time of the dripped resin composition according to the following standards.

⊚ Self-extinguishing time: less than 10 seconds

◯ Self-extinguishing time: 10 seconds or more but less than 30 seconds

Δ Self-extinguishing time: 30 seconds or more but less than 60 seconds

x Self-extinguishing time: 60 seconds or more

<Starting Materials for Examples and Comparative Examples>

(1) Rubber-Modified Styrenic Resin

The rubber-modified styrenic resins HIPS 1 to HIPS 10 were prepared by the procedures employed in Reference Examples 1 to 10, respectively.

### Reference Example 1

### Preparation Method of HIPS 1

A solution comprising 2 wt % of low cis polybutadiene rubber (residual unsaturated bonds: 36% of 1,4-cis bond, 52% of 1,4-trans bond and 12% of 1,2-vinyl bond, Mooney viscosity: 55, and 5% styrene solution viscosity: 165 cP) dissolved in 85 wt % of styrene monomer was prepared. This solution was incorporated with 12 wt % of ethylbenzene, 0.03 wt % of 1,1-bis(t-butylperoxy)3,3,5-trimethylcyclohexane (Perhexa 3M, NOF Corp.), 0.10 wt % of α-methyl styrene dimer and 0.05 wt % of antioxidant, to prepare the starting solution. The starting solution was continuously supplied to an agitator-equipped tank type first reactor (inner volume: 6 L) at 2 L/hour, where the temperature in the tank was controlled in such a way to have a solid concentration of 30% at the first reactor outlet to complete the phase inversion and prepare the particles. Agitation speed in the first reactor was controlled adequately to keep the particle size of the rubber-like polymer particles in a given range. Successively, the polymerization was continued in an agitator-equipped tank type second reactor (inner volume: 6 L) and a third reactor of the same type and volume, where the temperature in each reactor was controlled to have a solid concentration at 50 to 60% at the second reactor outlet and 70 to 79% at the third reactor outlet. The effluent was then sent to a vacuum evaporator, where it was treated at 230° C. to remove the unreacted styrene monomer and solvent. It was granulated by an extruder to prepare the rubber-modified styrenic resin composition. The analyzed physical properties of the HIPS thus obtained are given in Table 1.

### Reference Example 2

### Preparation Method of HIPS 2

HIPS 2 was prepared in the same manner as in Reference Example 1, except that the contents of low cis polybutadiene rubber, 1,1-bis(t-butylperoxy)3,3,5-trimethylcyclohexane and α-methyl styrene dimer, and the agitation speed in the first reactor were adequately changed. The physical properties of the HIPS 2 thus obtained are given in Table 1.

### Reference Example 3

### Preparation Method of HIPS 3

HIPS 3 was prepared in the same manner as in Reference Example 1, except that the rubber to be used was replaced by high cis polybutadiene rubber (residual unsaturated bonds: 96% of 1,4-cis bond, 2% of 1,4-trans bond and 2% of 1,2-vinyl bond, Mooney viscosity: 43, and 5% styrene solution viscosity: 135 cP), the contents of 1,1-bis(t-butylperoxy)3,3,5-trimethylcyclohexane and α-methyl styrene dimer were adequately changed, the agitation speed in the first reactor was also adequately changed, and the extruder temperature was increased compared with that in Reference Example 1. The physical properties of the HIPS 3 thus obtained are given in Table 1.

### Reference Examples 4 and 5

### Preparation Methods of HIPSs 4 and 5

HIPSs 4 and 5 were prepared in the same manner as in Reference Example 1, except that the swelling indexes of the obtained HIPS were changed by controlling the extruder temperature in Reference Example 3. The physical properties of the HIPSs 4 and 5 thus obtained are given in Table 1.

### Reference Examples 6 and 7

### Preparation Methods of HIPSs 6 and 7

HIPSs 6 and 7 were prepared in the same manner as in Reference Example 1, except that the contents of low cis polybutadiene rubber, 1,1-bis(t-butylperoxy)3,3,5-trimethylcyclohexane and α-methyl styrene dimer, and the agitation speed in the first reactor were adequately changed. The physical properties of the HIPSs 6 and 7 thus obtained are given in Table 1.

### Reference Examples 8 and 9

### Preparation Methods of HIPSs 8 and 9

HIPSs 8 and 9 were prepared in the same manner as in Reference Example 3, except that the contents of 1,1-bis(t-butylperoxy)3,3,5-trimethylsiloxane and α-methyl styrene dimer, and the agitation speed in the first reactor were adequately changed. The physical properties of the HIPSs 8 and 9 thus obtained are given in Table 1.

### Reference Example 10

### Preparation Method of HIPS 10

A solution comprising 10 wt % of high cis polybutadiene rubber (residual unsaturated bonds: 96% of 1,4-cis bond, 2% of 1,4-trans bond and 2% of 1,2-vinyl bond, Mooney viscosity: 40, and 5% styrene solution viscosity: 60 cP) dissolved in 75 wt % of styrene monomer was prepared. This solution was incorporated with 14 wt % of ethylbenzene, 0.04 wt % of 1,1-bis(t-butylperoxy)3,3,5-trimethylcyclohexane (Perhexa 3M, NOF Corp.), 0.20 wt % of α-methyl styrene dimer and 0.05 wt % of antioxidant, to prepare the starting solution. The starting solution was continuously supplied to an agitator-equipped tank type first reactor (inner volume: 6 L) at 2 L/hour, where the temperature in the tank was controlled in such a way to have a solid concentration of 35% at the first reactor outlet to complete the phase inversion and prepare the particles. Agitation speed in the first reactor was set at 90 rpm. Successively, the polymerization was continued in an agitator-equipped tank type second reactor (inner volume: 6 L) and a third reactor of the same type and volume, where the temperature in each reactor was controlled to have a solid concentration at 55 to 60% at the second reactor outlet and 68 to 73% at the third reactor outlet. The effluent was sent to a vacuum evaporator, where it was treated at 230° C. to remove the unreacted styrene monomer and solvent. It was then granulated by an extruder to prepare the rubber-reinforced, styrenic resin composition (HIPS 10). The analyzed physical properties of the HIPS 10 thus obtained are given in Table 1.

### Reference Example 11

### Preparation Method of ABS1

A 10 L reactor was charged with 30 parts of solid polybutadiene latex (weight-average particle size: 0.32 μm) and 100 parts of ion-exchanged water, and after the vapor phase was purged with nitrogen, the initial solution was heated to 70° C. Then, an aqueous solution (A) having the following composition and monomer mixture solution (B) were added to a reactor continuously for 8 hours for polymerization. The reaction system was kept at 70° C. for 1 hour after completion of their addition to complete the reaction. The aqueous solution (A) had the following composition.

| | |
|---|---|
| Ferrous sulfate | 0.005 parts |
| Sodium formaldehyde sulfoxylate (SFS) | 0.1 parts |
| Disodium ethylenediaminetetraacetic acid (EDTA) | 0.05 parts |
| Ion-exchanged water | 50 parts |

The mixed monomer solution (B) had the following composition.

| | |
|---|---|
| Acrylonitrile | 21 parts |
| Styrene | 49 parts |
| t-dodecyl mercaptan (t-DM) | 0.8 parts |
| Cumene hydroperoxide (CHP) | 0.1 parts |

The ABS latex thus prepared was incorporated with an antioxidant, and then with aluminum sulfate at 1.0 parts in relation to the polymer content in the latex to be solidified. It was sufficiently dehydrated, washed with water and dried, to prepare a graft polymer powder (C). It was then mixed with a copolymer, prepared by solution polymerization of a monomer mixture of styrene (70%) and acrylonitrile (30%). The resulting mixture was kneaded into pellets in an extruder in such a way to have a rubber content of 15%. The other analyzed values of ABS1 thus prepared were gel content: 22.5%, gel content/rubber content ratio: 1.5, area-average particle size: 0.25 μm and reduced viscosity: 0.5.

### Reference Example 12

### Preparation Method of ABS2

ABS2 was prepared in the same manner as in Reference Example 10, except that a polybutadiene latex having a weight-average particle size of 0.12 μm was used instead of the latex in Reference Example 11. The analyzed physical properties of ABS2 obtained were rubber content: 15%, gel content: 21%, gel content/rubber content ratio: 1.4, area-average particle size: 0.1 μm and reduced viscosity: 0.5.

(2) Polyphenylene Ether

Polyphenylene ether (PPE) was prepared by the procedure employed in Reference Example 13.

### Reference Example 13

A stainless steel reactor, equipped with an oxygen blowing nozzle at the bottom of the reactor, and cooling coil and agitating blades inside, was charged with 8.75 kg of 2,6-xylenol dissolved in a mixed solvent of cupric bromide (54.8 g), di-n-butylamine (1110 g), toluene (20 L), n-butanol (16 L) and methanol (4 L), after it was sufficiently purged with nitrogen. The polymerization was carried out for 180 minutes, while the system temperature was kept at 30° C. with stirring and oxygen continuously blown. On completion of the polymerization, the precipitated polymer was separated by filtration. Added thereto is a mixed solution of methanol and hydrochloric acid to decompose the catalyst remaining in the polymer, and then sufficiently washed with methanol and dried, to prepare powdery polyphenylene ether (hereinafter referred to as PPE). It had a reduced viscosity ηsp of 0.55 dL/g.

(3) Component (B)

As the component (B) (each of B-1 to B-4) represented by the formula (4), one having substituents R and R′ given in Table 2 is used. As the component (B) (B-5) represented by the formula (5), one having substituents R and R′ also given in Table 2 is used. Their physical properties are given in Table 2.

The component B-6 was prepared by the following procedure. First, 1000 g of an aqueous solution of copolymer of styrene/sodium-p-styrenesulfonate (styrene/sodium-p-styrenesulfonate molar ratio: 50%/50%) having weight-average molecular weight: 43,000 and solid content: 22% was incorporated with 250 g of tetraphenylphosphine chloride. The mixture was heated at 90° C. with stirring to produce a phosphonium. Next, the effluent solution was washed with hot water (80° C.) to remove sodium and chloride ions, and then dried at 100° C. under a vacuum. The product was a copolymer of styrene/tetraphenylphosphonium-p-styrenesulfonate. Its properties are given in Table 2.

(4) Component (C)

The following compounds were used as the component (C).

C-1: Commercial triphenyl phosphate

C-2: Compounds represented by the formula (7) (CR733S, Daihachi Chemical Industry Co., Ltd.), wherein the compound of n=1 accounts for 65 wt % and the compounds of n≧2 accounts for 35 wt %. 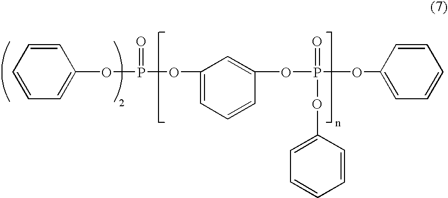
C-3: Compounds represented by the formula (8) (CR741, Daihachi Chemical Industry Co., Ltd.), wherein the compound of n=1 accounts for 85 wt % and the compounds of n≧2 accounts for 13 wt %.

It has a residue after thermal weight loss of 4% at 500° C. and molecular weight (average value) of 739, and is liquid at normal temperature. 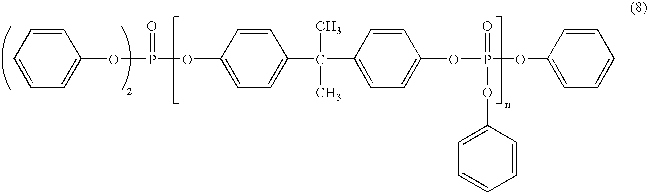
C-4: Compounds represented by the formula (9) (PX200, Daihachi Chemical Industry Co., Ltd.).

It has a residue after thermal weight loss of 4% at 500° C., melting point of 96° C. and molecular weight of 686. 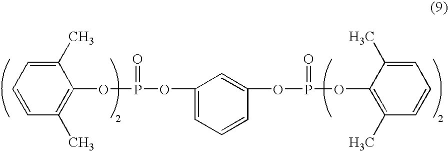
(5) Component (D)

The following compounds were used as the component (D).

D-1: Copolymer of styrene/acrylic acid ester compound (ARUFON/XFM-920, Toagosei Co., Ltd., Tg: 51° C., weight-average molecular weight: 3,800)

D-2: Copolymer of butyl acrylate/2-ethylhexyl acrylate (ARUFON/UP-1021, Toagosei Co., Ltd, Tg: −71° C., weight-average molecular weight: 1,600)

### Comparative Examples 1 and 2

The components (A) and (B) each having the composition given in Table 3 and 0.2 parts of zinc stearate as a releasing agent were all mixed together, and molten and extruded at 250° C. by a twin-screw extruder (ZSK 25 mm, Coperion Welner & Pfleiderer, L/D=42) into pellets under the conditions of screw rotating speed: 300 rpm and discharge rate: 10 kg/hour. The pellets obtained were molded by the injection molder described above to prepare the molded specimen, which was evaluated for its physical properties and fire retardancy. The results are given in Table 3. The composition prepared in Comparative Example 1 exhibited no fire retardancy because of lack of the component (B), whereas the one prepared in Comparative Example 2 exhibited a deteriorated fire retardancy of the dripped composition because of its insufficient content of the component (B).

### Example 1

The composition was prepared by extrusion and molding in the same manner as in Comparative Example 2, except the content of the component (B) was changed as shown in Table 3. It was tested also in the same manner. The results are given in Table 3. Both of them exhibited well-balanced physical properties, releasability and mold contamination resistance, and satisfied the UL's V-2 fire retardancy requirement.

### Examples 2 to 6

The composition, shown in Table 3, was prepared by extrusion and molding in the same manner as in Example 1, except that the kneading conditions were changed. It was tested also in the same manner. The dispersed particle size of component (B) exhibited a varying size depending on the kneading conditions. The one prepared in Example 2, which had a low particle size ratio (Df/Dr), exhibited the best balanced physical properties and fire retardancy. The one prepared in Example 4, which had a particle size ratio of above 1, exhibited slightly deteriorated fire retardancy and releasability. Preferably, each of those prepared in Examples 2, 3 and 5 exhibited an improved self-extinguishing capacity of the dripped composition.

### Examples 7 to 15

The composition was prepared by extrusion and molding in the same manner as in Example 1, except the rubber-modified polystyrene resin to be used was changed to the one given in Table 4 or 5, and the composition and kneading conditions were changed to the those given in Table 4 or 5. It was tested also in the same manner. In particular, the composition prepared in each of Examples 7 and 8, which used HIPS3 of high cis polybutadiene rubber, preferably exhibited excellent balanced falling dart impact strength and rigidity than the one which used the low cis polybutadiene, and hence was particularly preferable. The one prepared in Example 8 was particularly preferable because of its improved self-extinguishing capacity of the dripped composition. Examples 9 and 10 also used the high cis polybutadiene rubber. The one prepared in Example 9, which used HIPS4 of high swelling index, exhibited slightly deteriorated falling dart impact strength, its retention, gloss and rigidity. The one prepared in Example 10, which used HIPS5 of low swelling index, exhibited slightly deteriorated Charpy impact strength and falling dart impact strength. The one prepared in Example 12 has, under the kneading condition, a larger dispersed particle size of the fire retardant component, and as a result has slightly deteriorated falling dart impact strength retention, gloss and its retention, because of an increased particle size ratio (Df/Dr). The one prepared in Example 14, which used HIPS8 of high gel content/rubber content ratio ((b)/(a)), exhibited slightly deteriorated falling dart impact strength and flexural modulus. The one prepared in Example 15, which used HIPS9 including a rubber-like polymer of large area-average particle size, exhibited slightly deteriorated gloss and its retention.

### Comparative Examples 3 and 4

The composition was prepared by extrusion and molding in the same manner as in Example 1, except that the kneading conditions were changed as shown in Table 4 or 6. It was also tested in the same manner. The extrusion temperature used was lower than the melting point of the component (B), which increased the dispersed particle size of the fire retardant component beyond the range for the present invention, leading to deteriorated falling dart impact strength, gloss and its retention, fire retardancy and releasability of each resin composition.

### Examples 16 to 18

The composition was prepared by extrusion and molding in the same manner as in Example 1, except ABS1 or ABS2 prepared in Reference Example 10 or 11 was used as the rubber-modified styrenic resin and the kneading conditions were changed to those given in Table 5. It was tested also in the same manner. The composition prepared in Example 14, having a relatively large particle size ratio (Df/Dr), exhibited slightly deteriorated falling dart impact strength, rigidity, gloss retention and fire retardancy.

### Examples 19 to 23

The composition was prepared by extrusion and molding in the same manner as in Example 1, except that the fire retardant component (B) to be used and kneading conditions were changed to those given in Table 6. It was tested also in the same manner. The composition prepared in Example 23 exhibited slightly deteriorated falling dart impact strength retention, gloss retention and fire retardancy, because the fire retardant component had a slightly increased dispersed particle size. The compositions of the other Examples exhibited well-balanced physical properties and good fire retardancy. The one prepared in Example 21, in particular, was preferable because of its improved self-extinguishing capacity of the dripped composition.

### Comparative Example 5

The composition prepared in Comparative Example 5, which used the fire retardant component B-6 having a molecular weight beyond the range for the present invention, exhibited deteriorated falling dart impact strength, releasability, gloss and its retention and fire retardancy. The results are given in Table 6.

### Comparative Examples 6 and 7

The composition was prepared by mixing the components all together, and extruding and molding in the same manner as in Example 1, except that the fire retardant component given in Table 7 having no melting point of 400° C. or lower was used instead of the fire retardant component (B) of the invention. It was tested also in the same manner. The composition prepared in Comparative Example 6 exhibited deteriorated gloss and fire retardancy. The one prepared in Comparative Example 7 exhibited a deteriorated fire retardancy, because the fire retardant component, although very finely dispersed, had characteristics beyond the ranges for the present invention.

### Comparative Examples 8 to 10

The composition was prepared by molding in the same manner as in Example 1, except that the component (A) given in Table 7 and 0.2 parts of zinc stearate as a releasing agent were mixed, and the component (C) supplied as a side feed to halfway through the extruder was molten and extruded at 230° C. It was tested also in the same manner. Each of the compositions of the Comparative Examples exhibited deteriorated thermal deformation temperature and fire retardancy, because the fire retardant was not dispersed in the resin.

### Comparative Example 11

The composition was prepared by extrusion and molding in the same manner as in Example 1, except that the components given in Table 7 were all mixed together. It was tested also in the same manner. The composition of the Comparative Example exhibited deteriorated thermal deformation temperature and fire retardancy, because the fire retardant was not dispersed in the resin.

### Examples 24 to 28

The composition was prepared by extrusion and molding in the same manner as in Example 1, except that the components (A) to (D) having the composition given in Table 7 or 8 were mixed all together and the temperatures of the extrusion were changed to those given in Table 7 or 8. It was tested also in the same manner. Each composition of the Examples exhibited well-balanced mechanical physical properties and good fire retardancy. The one prepared in Example 28, having a small dispersed particle size and a very low particle size ratio (Df/Dr), exhibited slightly deteriorated thermal deformation temperature and fire retardancy.

### Examples 29 to 33

The composition was prepared by extrusion and molding in the same manner as in Example 1, except that the composition and extrusion condition were changed to those given in Table 8. It was tested also in the same manner. In Examples 30 to 32, the component (C) was supplied as a side feed to halfway through the extruder. Each composition of the Examples exhibited well-balanced physical properties and good fire retardancy.

### Examples 34 to 37

The composition was prepared by extrusion and molding in the same manner as in Example 1, except that a small quantity of polyphenylene ether (PPE) was incorporated as given in Table 9 and other conditions were changed to those given in Table 9. It was tested also in the same manner. The results are given in Table 9. Each composition of the Examples exhibited well-balanced physical properties, and good releasability and mold contamination resistance. Each also exhibited the self-extinguishing capacity of the dripped composition. In particular, the composition prepared in each of Examples 34 to 36, wherein the component (B) having a small dispersed particle size is used, preferably exhibited very well-balanced physical properties. The composition prepared in Example 37 had, under the kneading condition, a bit larger dispersed particle size of the component (B), and as a result had a slightly deteriorated falling dart impact strength, because of the particle size ratio (Df/Dr) exceeding 1.

### Comparative Example 12

The composition was prepared by extrusion and molding in the same manner as in Example 1, except that the kneading condition was changed as given in Table 9. It was tested also in the same manner. The composition of the Comparative Example exhibited had, under the kneading condition, a larger dispersed particle size of the fire retardant component beyond the range of the present invention and as a result had deteriorated falling dart impact strength, gloss and its retention, fire retardancy and releasability.

### Comparative Example 13

The composition was prepared by extrusion and molding in the same manner as in Example 1, except that no fire retardant component (B) was incorporated and other conditions were changed as given in Table 9. It was tested also in the same manner. The composition of the Comparative Example exhibited a deteriorated fire retardancy, because of lack of fire retardant component (B).

### Examples 38 to 42

The composition was prepared by extrusion and molding in the same manner as in Example 1, except that the rubber-modified styrenic resin (A) to be used was changed to the one given in Table 9 or 10. It was tested also in the same manner. Each composition of the Examples exhibited a good fire retardancy. Those prepared in Examples 38 to 48, in particular, exhibited very well-balanced physical properties.

### Examples 43 to 49

The composition was prepared by extrusion and molding in the same manner as in Example 1, except that the fire retardant component (B) to be used and the kneading condition were changed to those given in Table 11. It was tested also in the same manner. Very preferably, each composition of the Examples exhibited well-balanced physical properties and good fire retardancy.

### Examples 50 to 52

The composition was prepared by mixing the components all together, extrusion and molding in the same manner as in Example 1, except that the contents of the components (A) and (B) were changed to those given in Table 12. It was tested also in the same manner. The composition prepared in each of Examples 50 and 52 exhibited very good self-extinguishing capacity of the dripped composition because of its higher content of added PPE, which was however accompanied by a slightly deteriorated fluidity (spiral flow). The one prepared in Example 51 exhibited a very good self-extinguishing capacity of the dripped composition because of its higher content of the added fire retardant component (B), which was however accompanied by slightly deteriorated impact strengths (Charpy impact strength and falling dart impact strength).

### Examples 53 and 54

The composition was prepared by molding in the same manner as in Example 1, except that the components (A) and (B) given in Table 13 were used, 0.2 parts of zinc stearate was incorporated as a releasing agent, and the component (C) supplied as a side feed to halfway through the extruder was molten and extruded at 250° C. It was tested also in the same manner. Very preferably, each composition of the Examples exhibited well-balanced physical properties and good fire retardancy.

### Examples 55 and 57

The composition was prepared by molding in the same manner as in Example 1, except that the components (A), (B) and (C) given in Table 13 were used and 0.2 parts of zinc stearate as a releasing agent were mixed all together. It was tested also in the same manner. Very preferably, each composition of the Examples exhibited well-balanced physical properties and good fire retardancy.

### Comparative Example 14

The composition was prepared by molding in the same manner as in Example 1, except that the component (A) given in Table 13 was used, 0.2 parts of zinc stearate was incorporated as a releasing agent and the component (C) supplied as a side feed to halfway through the extruder was molten and extruded at 250° C. It was tested also in the same manner. The composition of the Comparative Example exhibited a deteriorated fire retardancy, because of lack of fire retardant component (B).

### Example 56

The composition was prepared by molding in the same manner as in Example 1, except that the components (A) and (B) given in Table 13 were used, 0.2 parts of zinc stearate was incorporated as a releasing agent, and the component (C) supplied as a side feed to halfway through the extruder was molten and extruded at 250° C. It was tested also in the same manner. It was found that the composition exhibited slightly deteriorated impact strength and heat resistance, when the component (C) was incorporated in excess of the component (B).

### Examples 58 and 59

The composition was prepared by extrusion and molding in the same manner as in Example 1, except that the components were mixed all together as the composition given in Table 13. It was also tested in the same manner. Each composition of the Examples exhibited well-balanced physical properties and good fire retardancy.

### Examples 60 to 65

The composition was prepared by extrusion and molding in the same manner as in Example 1, except that the content of PPE was increased for the component (A), and the composition and extrusion conditions given in Table 14 were used. It was tested also in the same manner. In Example 62, the component (C) was supplied as a side feed to halfway through the extruder. The results are given in Table 14. Each composition of the Examples exhibited well-balanced mechanical physical properties, good releasability and mold contamination resistance, and high fire retardant capacity which satisfied the V-1 and V-0 requirements.

### Comparative Example 15

The composition was prepared by extrusion and molding in the same manner as in Example 1, except that the content of PPE was increased for the component (A), and the composition and extrusion condition given in Table 14 were used. It was tested also in the same manner. The Comparative Example employed a kneading condition of a lower extrusion temperature than the melting point of the component (B) and a lower rotation speed as an index for shearing. As a result, the dispersed particle size of the component (B) is increased beyond the range for the present invention, leading to deteriorated falling dart impact strength, gloss and its retention, releasability and fire retardancy of the composition.

### Comparative Example 16

The composition was prepared by extrusion and molding in the same manner as in Example 62, except that the component (C) given in Table 15 was used instead of the component (B). It was tested also in the same manner. The results are given in Table 15. In the Comparative Example, the composition exhibited lower releasability, mold contamination resistance and fire retardancy than the composition incorporated with the component (B), e.g., that prepared in Example 63, because the fire retardant was not dispersed in the resin in the form of particles.

### Comparative Example 17

The composition was prepared by extrusion and molding in the same manner as in Comparative Example 16, except that 1.0 part of zinc stearate was incorporated as a releasing agent. It was tested also in the same manner. The results are given in Table 15. The composition of the Comparative Example exhibited an improved releasability but a deteriorated mold contamination resistance.

### Comparative Example 18

The composition was prepared by extrusion and molding in the same manner as in Example 1, except that the content of PPE was increased to 45 wt % for the component (A). It was tested also in the same manner. The results are given in Table 15. In the Comparative Example, the composition exhibited good thermal deformation temperature and fire retardancy, but greatly deteriorated releasability and fluidity.

### Comparative Example 19

The composition was prepared by extrusion and molding in the same manner as in Example 1, except that the fire retardant component B-6 having a molecular weight beyond the range for the present invention was used. It was tested also in the same manner. The results are given in Table 15. In the Comparative Example, the composition exhibited deteriorated releasability and fluidity.

### Comparative Example 20

The composition was prepared by extrusion and molding in the same manner as in Example 1, except that PPE was not incorporated and the fire retardant component B-6 having a molecular weight beyond the range for the present invention was used at a high content. It was tested also in the same manner. The results are given in Table 15. In the Comparative Example, the composition exhibited greatly deteriorated releasability and falling dart impact strength.

TABLE 1

| | | | | | | | | | | Reference |
|---|---|---|---|---|---|---|---|---|---|---|
| | | | | | | | | | | Example |
| | Reference | Reference | Reference | Reference | Reference | Reference | Reference | Reference | Reference | 10 |
| | Example 1 | Example 2 | Example 3 | Example 4 | Example 5 | Example 6 | Example 7 | Example 8 | Example 9 | HIPS |
| | HIPS 1 | HIPS 2 | HIPS 3 | HIPS 4 | HIPS 5 | HIPS 6 | HIPS 7 | HIPS 8 | HIPS 9 | 10 |
| Content of | 35 | 35 | 98 | 98 | 98 | 35 | 35 | 98 | 98 | 98 |
| cis 1.4 | | | | | | | | | | |
| bond (%) | | | | | | | | | | |
| Rubber | 3 | 5 | 8 | 8 | 8 | 6 | 10 | 8 | 8 | 12 |
| content | | | | | | | | | | |
| (a) (%) | | | | | | | | | | |
| Gel | 15 | 15 | 25 | 25 | 25 | 20 | 28 | 32 | 28 | 30 |
| content | | | | | | | | | | |
| (b) (%) | | | | | | | | | | |
| (b)/(a) | 5.0 | 3.0 | 3.1 | 3.1 | 3.1 | 3.3 | 2.8 | 4.0 | 3.5 | 2.5 |
| Area- | 1.6 | 1.3 | 1.2 | 1.2 | 1.2 | 0.52 | 1.3 | 1.5 | 2.6 | 1.4 |
| average | | | | | | | | | | |
| particle | | | | | | | | | | |
| size | | | | | | | | | | |
| Dr(μm) | | | | | | | | | | |
| Swelling | 10.0 | 10.5 | 10.0 | 12.0 | 8.0 | 9.5 | 11.0 | 10.5 | 12.0 | 11.0 |
| index | | | | | | | | | | |
| Reduced | 0.7 | 0.7 | 0.7 | 0.7 | 0.7 | 0.7 | 0.53 | 0.7 | 0.7 | 0.53 |
| viscosity | | | | | | | | | | |
| (dl/g) | | | | | | | | | | |

TABLE 2

| | B-1 | B-2 | B-3 | B-4 | B-5 | B-6 |
|---|---|---|---|---|---|---|
| R and R′ in the formula (5) | Benzyl | Phenyl | Methyl | Phenethyl | — | |
| R and R′ in the formula (6) | — | — | — | — | Phenyl | |
| Residue after | 29 | 32 | 28 | 26 | 35 | 36 |
| thermal weight loss | | | | | | |
| at 500° C. (%) | | | | | | |
| Melting point (° C.) | 255 | 265 | 248 | 250 | 194 | 192 |
| Molecular weight | 317 | 303 | 241 | 345 | 335 | 43000 |

TABLE 3

| | Comparative | Comparative | | | | | | |
|---|---|---|---|---|---|---|---|---|
| | Example 1 | Example 2 | Example 1 | Example 2 | Example 3 | Example 4 | Example 5 | Example 6 |
| Component (A) | | | | | | | | |
| HIPS type | HIPS2 | HIPS2 | HIPS2 | HIPS2 | HIPS2 | HIPS2 | HIPS2 | HIPS1 |
| Incorporated amount (Parts by weight) | 100 | 100 | 100 | 100 | 100 | 100 | 100 | 100 |
| Residue after thermal weight loss (%) | 2 | 2 | 2 | 2 | 2 | 2 | 2 | 2 |
| Component (B) | | | | | | | | |
| Type | Not used | B-1 | B-1 | B-1 | B-1 | B-1 | B-1 | B-1 |
| Incorporated amount (parts by weight) | — | 0.3 | 3 | 7 | 7 | 7 | 15 | 3 |
| Kneading conditions | | | | | | | | |
| Extrusion temperature (° C.) | 250 | 250 | 250 | 250 | 250 | 220 | 250 | 250 |
| Speed of rotation (rmp) | 300 | 300 | 300 | 300 | 200 | 200 | 300 | 300 |
| Area-average particle size of the | | | | | | | | |
| component (B) | | | | | | | | |
| Particle size Df(μm) | — | 0.12 | 0.15 | 0.25 | 1.2 | 1.4 | 1.5 | 0.12 |
| Particle size ratio (Df/Dr) | — | 0.09 | 0.12 | 0.19 | 0.92 | 1.1 | 1.2 | 0.08 |
| Physical Properties | | | | | | | | |
| Charpy impact strength (KJ/m²) | 10 | 10 | 9 | 6 | 5 | 5 | 3 | 5 |
| Falling dart impact strength (kg · cm) | 20 | 20 | 20 | 16 | 14 | 11 | 7 | 14 |
| Falling dart impact strength retention (%) | — | 100 | 100 | 80 | 70 | 55 | 35 | 93 |
| Flexural modulus (MPa) | 2,530 | 2,540 | 2,630 | 2,770 | 2,700 | 2,680 | 3,070 | 2,900 |
| Thermal deformation temperature (° C.) | 74 | 74 | 75 | 76 | 76 | 75 | 76 | 76 |
| Melt flow rate (g/10 minutes) | 7 | 7 | 7 | 8 | 8 | 8 | 10 | 8 |
| Spiral flow (cm) | 43 | 43 | 45 | 50 | 48 | 48 | 54 | 50 |
| Gloss (%) | 78 | 78 | 78 | 77 | 73 | 69 | 68 | 76 |
| Gloss retention (%) | — | 100 | 100 | 99 | 94 | 88 | 87 | 100 |
| Releasability | ⊚ | ⊚ | ⊚ | ⊚ | ⊚ | ◯ | ◯ | ⊚ |
| Mold contamination resistance | ◯ | ◯ | ◯ | ◯ | ◯ | ◯ | ◯ | ◯ |
| UL94 fire retardancy (3.0 mm) | Not passed | Not passed | V-2 | V-2 | V-2 | V-2 | V-2 | V-2 |
| UL94 fire retardancy (1.5 mm) | Not passed | Not passed | V-2 | V-2 | V-2 | Not passed | V-2 | V-2 |
| Self-extinguishing time of dripped resin | X | X | X | ◯ | ◯ | Δ | ⊚ | X |
| composition | | | | | | | | |

TABLE 4

| | | Comparative | | | Example | Example | Example | Example |
|---|---|---|---|---|---|---|---|---|
| | Example 7 | Example 3 | Example 8 | Example 9 | 10 | 11 | 12 | 13 |
| Component (A) | | | | | | | | |
| HIPS type | HIPS3 | HIPS3 | HIPS3 | HIPS4 | HIPS5 | HIPS6 | HIPS6 | HIPS7 |
| Incorporated amount (Parts by weight) | 100 | 100 | 100 | 100 | 100 | 100 | 100 | 100 |
| Residue after thermal weight loss (%) | 2 | 2 | 2 | 2 | 2 | 2 | 2 | 2 |
| Component (B) | | | | | | | | |
| Type | B-1 | B-1 | B-1 | B-1 | B-1 | B-1 | B-1 | B-1 |
| Incorporated amount (parts by weight) | 3 | 7 | 7 | 7 | 7 | 3 | 3 | 3 |
| Kneading conditions | | | | | | | | |
| Extrusion temperature (° C.) | 250 | 180 | 260 | 260 | 260 | 250 | 200 | 250 |
| Speed of rotation (rmp) | 300 | 250 | 250 | 250 | 250 | 300 | 300 | 300 |
| Area-average particle size of the | | | | | | | | |
| component (B) | | | | | | | | |
| Particle size Df(μm) | 0.11 | 4.0 | 0.2 | 0.2 | 0.2 | 0.12 | 1.0 | 0.12 |
| Particle size ratio (Df/Dr) | 0.09 | 3.33 | 0.17 | 0.17 | 0.17 | 0.29 | 1.92 | 0.09 |
| Physical properties | | | | | | | | |
| Charpy impact strength (KJ/m²) | 12 | 5 | 8 | 10 | 6 | 8 | 7 | 12 |
| Falling dart impact strength (kg · cm) | 45 | 15 | 40 | 25 | 28 | 24 | 18 | 38 |
| Falling dart impact strength | 100 | 33 | 89 | 56 | 62 | 80 | 60 | 86 |
| retention (%) | | | | | | | | |
| Flexural modulus (MPa) | 2,400 | 2,310 | 2,480 | 2,350 | 2,540 | 2,700 | 2,600 | 2,200 |
| Thermal deformation temperature (° C.) | 74 | 73 | 75 | 75 | 75 | 75 | 74 | 73 |
| Melt flow rate (g/10 minutes) | 7 | 7 | 7 | 7 | 7 | 7 | 7 | 9 |
| Spiral flow (cm) | 40 | 45 | 48 | 47 | 50 | 51 | 50 | 45 |
| Gloss (%) | 75 | 45 | 73 | 66 | 74 | 88 | 75 | 72 |
| Gloss retention (%) | 100 | 60 | 97 | 88 | 99 | 100 | 85 | 99 |
| Releasability | ⊚ | Δ | ⊚ | ◯ | ⊚ | ⊚ | ◯ | ⊚ |
| Mold contamination resistance | ◯ | ◯ | ◯ | ◯ | ◯ | ◯ | ◯ | ◯ |
| UL94 fire retardancy (3.0 mm) | V-2 | Not passed | V-2 | V-2 | V-2 | V-2 | V-2 | V-2 |
| UL94 fire retardancy (1.5 mm) | V-2 | V-2 | V-2 | V-2 | V-2 | V-2 | V-2 | V-2 |
| Self-extinguishing time of dripped resin | X | X | ◯ | ◯ | ◯ | X | X | X |
| composition | | | | | | | | |

TABLE 5

| | Example | Example | Example | Example | Example |
|---|---|---|---|---|---|
| | 14 | 15 | 16 | 17 | 18 |
| Component (A) | | | | | |
| HIPS type | HIPS8 | HIPS9 | ABS1 | ABS1 | ABS2 |
| Incorporated amount (Parts by weight) | 100 | 100 | 100 | 100 | 100 |
| Residue after thermal weight loss (%) | 2 | 2 | 4 | 4 | 4 |
| Component (B) | | | | | |
| Type | B-1 | B-1 | B-1 | B-1 | B-1 |
| Incorporated amount (parts by weight) | 7 | 7 | 3 | 3 | 3 |
| Kneading conditions | | | | | |
| Extrusion temperature (° C.) | 260 | 260 | 200 | 250 | 250 |
| Speed of rotation (rmp) | 250 | 250 | 300 | 300 | 300 |
| Area-average particle size of the | | | | | |
| component (B) | | | | | |
| Particle size Df(μm) | 0.2 | 0.2 | 0.35 | 0.12 | 0.10 |
| Particle size ratio (Df/Dr) | 0.13 | 0.08 | 1.4 | 0.48 | 1.0 |
| Physical properties | | | | | |
| Charpy impact strength (KJ/m²) | 6 | 8 | 15 | 21 | 9 |
| Falling dart impact strength (kg · cm) | 35 | 40 | 35 | 50 | 16 |
| Falling dart impact strength retention (%) | 70 | 70 | 65 | 92 | 85 |
| Flexural modulus (MPa) | 2,210 | 2,310 | 2,800 | 2,910 | 2,980 |
| Thermal deformation temperature (° C.) | 74 | 69 | 78 | 80 | 81 |
| Melt flow rate (g/10 minutes) | 6 | 7 | 2 | 2 | 2 |
| Spiral flow (cm) | 38 | 35 | 15 | 14 | 13 |
| Gloss (%) | 73 | 51 | 86 | 96 | 99 |
| Gloss retention (%) | 97 | 85 | 89 | 100 | 100 |
| Releasability | ◯ | Δ | ◯ | ◯ | ◯ |
| Mold contamination resistance | ◯ | ◯ | ◯ | ◯ | ◯ |
| UL94 fire retardancy (3.0 mm) | V-2 | V-2 | Not passed | V-2 | V-2 |
| UL94 fire retardancy (1.5 mm) | V-2 | Not passed | V-2 | V-2 | V-2 |
| Self-extinguishing time of dripped resin | ◯ | Δ | X | X | X |
| composition | | | | | |

TABLE 6

| | Comparative | Example | Example | Example | Example | Example | Comparative |
|---|---|---|---|---|---|---|---|
| | Example 4 | 19 | 20 | 21 | 22 | 23 | Example 5 |
| Component (A) | | | | | | | |
| HIPS type | HIPS2 | HIPS2 | HIPS2 | HIPS3 | HIPS2 | HIPS3 | HIPS3 |
| Incorporated amount (Parts by weight) | 100 | 100 | 100 | 100 | 100 | 100 | 100 |
| Residue after thermal weight loss (%) | 2 | 2 | 2 | 2 | 2 | 2 | 2 |
| Component (B) | | | | | | | |
| Type | B-2 | B-2 | B-3 | B-3 | B-4 | B-5 | B-6 |
| Incorporated amount (parts by weight) | 5 | 5 | 5 | 7 | 5 | 7 | 10 |
| Kneading conditions | | | | | | | |
| Extrusion temperature (° C.) | 180 | 260 | 250 | 260 | 250 | 220 | 220 |
| Speed of rotation (rmp) | 250 | 300 | 300 | 250 | 300 | 250 | 250 |
| Area-average particle size of the | | | | | | | |
| component (B) | | | | | | | |
| Particle size Df(μm) | 3.2 | 0.2 | 0.25 | 0.4 | 0.09 | 2.0 | 1.7 |
| Particle size ratio (Df/Dr) | 2.46 | 0.15 | 0.19 | 0.33 | 0.07 | 1.67 | 1.41 |
| Physical properties | | | | | | | |
| Charpy impact strength (KJ/m²) | 4 | 7 | 7 | 7 | 8 | 6 | 6 |
| Falling dart impact strength (kg · cm) | 8 | 18 | 17 | 32 | 20 | 22 | 13 |
| Falling dart impact strength retention (%) | 40 | 90 | 85 | 71 | 100 | 49 | 29 |
| Flexural modulus (MPa) | 2,600 | 2,650 | 2,650 | 2,380 | 2,680 | 2,330 | 2,320 |
| Thermal deformation temperature (° C.) | 72 | 73 | 73 | 75 | 72 | 74 | 70 |
| Melt flow rate (g/10 minutes) | 8 | 8 | 8 | 6 | 9 | 8 | 10 |
| Spiral flow (cm) | 48 | 46 | 49 | 42 | 52 | 45 | 56 |
| Gloss (%) | 50 | 76 | 75 | 68 | 78 | 61 | 58 |
| Gloss retention (%) | 64 | 97 | 96 | 91 | 100 | 81 | 77 |
| Releasability | ⊚ | ◯ | ◯ | ◯ | ⊚ | ◯ | X |
| Mold contamination resistance | ◯ | ◯ | ◯ | ◯ | ◯ | ◯ | ◯ |
| UL94 fire retardancy (3.0 mm) | V-2 | V-2 | V-2 | V-2 | V-2 | V-2 | V-2 |
| UL94 fire retardancy (1.5 mm) | Not passed | V-2 | V-2 | V-2 | V-2 | V-2 | Not passed |
| Self-extinguishing time of dripped resin | Δ | Δ | Δ | ◯ | Δ | Δ | X |
| composition | | | | | | | |

TABLE 7

| | Comparative | Comparative | Comparative | Comparative | Comparative | Comparative | Example | Example |
|---|---|---|---|---|---|---|---|---|
| | Example 6 | Example 7 | Example 8 | Example 9 | Example 10 | Example 11 | 24 | 25 |
| Component (A) | | | | | | | | |
| HIPS type | HIPS2 | HIPS2 | HIPS2 | HIPS2 | HIPS2 | HIPS2 | HIPS2 | HIPS3 |
| Incorporated amount (Parts by weight) | 100 | 100 | 100 | 100 | 100 | 100 | 100 | 100 |
| Residue after thermal weight loss (%) | 2 | 2 | 2 | 2 | 2 | 2 | 2 | 2 |
| Component (B) | | | | | | | | |
| Type | *1 | *2 | Not used | Not used | Not used | Not used | B-1 | B-5 |
| Incorporated amount (parts by weight) | 10 | 5 | — | — | — | — | 3 | 7 |
| Component (C) | | | | | | | | |
| Type | Not used | Not used | C-1 | C-2 | C-3 | C-4 | Not used | Not used |
| Incorporated amount (parts by weight) | — | — | 7 | 7 | 7 | 7 | — | — |
| Component (D) | | | | | | | | |
| Type | Not used | Not used | Not used | Not used | Not used | Not used | D-1 | D-1 |
| Incorporated amount (parts by weight) | — | — | — | — | — | — | 2 | 5 |
| Kneading conditions | | | | | | | | |
| Extrusion temperature (° C.) | 230 | 250 | 230 | 230 | 230 | 230 | 250 | 220 |
| Speed of rotation (rmp) | 300 | 300 | 300 | 300 | 300 | 300 | 300 | 250 |
| Area-average particle size of the fire | | | | | | | | |
| retardant component | | | | | | | | |
| Particle size Df(μm) | 2.3 | 0.02 | — | — | — | — | 0.10 | 1.2 |
| Particle size ratio (Df/Dr) | 1.8 | 0.02 | — | — | — | — | 0.08 | 1.0 |
| Physical properties | | | | | | | | |
| Charpy impact strength (KJ/m²) | 3 | 5 | 7 | 7 | 7 | 8 | 7 | 8 |
| Falling dart impact strength (kg · cm) | 5 | 17 | 18 | 17 | 18 | 17 | 20 | 27 |
| Falling dart impact strength | 25 | 85 | 90 | 85 | 90 | 85 | 100 | 60 |
| retention (%) | | | | | | | | |
| Flexural modulus (MPa) | 3,200 | 2,900 | 2,600 | 2,610 | 2,620 | 2,650 | 2,650 | 2,500 |
| Thermal deformation temperature (° C.) | 78 | 76 | 66 | 64 | 67 | 68 | 72 | 72 |
| Melt flow rate (g/10 minutes) | 5 | 8 | 14 | 15 | 13 | 12 | 9 | 10 |
| Spiral flow (cm) | 17 | 38 | 68 | 65 | 61 | 59 | 51 | 52 |
| Gloss (%) | 35 | 73 | 78 | 78 | 78 | 78 | 78 | 72 |
| Gloss retention (%) | 45 | 94 | 100 | 100 | 100 | 100 | 100 | 96 |
| Releasability | X | ⊚ | Δ | Δ | Δ | ◯ | ⊚ | ◯ |
| Mold contamination resistance | ◯ | ◯ | X | Δ | ◯ | ◯ | ◯ | ◯ |
| UL94 fire retardancy (3.0 mm) | Not passed | Not passed | V-2 | Not passed | Not passed | Not passed | V-2 | V-2 |
| UL94 fire retardancy (1.5 mm) | Not passed | Not passed | V-2 | V-2 | Not passed | V-2 | V-2 | V-2 |
| Self-extinguishing time of dripped | X | X | X | X | X | X | X | ◯ |
| resin composition | | | | | | | | |

*1 Magnesium hydroxide (KISUMA 5B, Kyowa Chemical Industry, Co., Ltd. Average secondary particle size 0.8 μm)
*2 Silicon dioxide (AEROSIL 200, Nippon Aerosil, Co., Ltd. Average primary particle size: 5 nm)
(*1 and *2 had no melting point equal to or below 400° C.)

TABLE 8

| | Example | Example | Example | Example | Example | Example | Example | Example |
|---|---|---|---|---|---|---|---|---|
| | 26 | 27 | 28 | 29 | 30 | 31 | 32 | 33 |
| Component (A) | | | | | | | | |
| HIPS type | HIPS2 | HIPS2 | HIPS2 | HIPS2 | HIPS2 | HIPS2 | HIPS3 | HIPS2 |
| Incorporated amount (Parts by weight) | 100 | 100 | 100 | 100 | 100 | 100 | 100 | 100 |
| Residue after thermal weight loss (%) | 2 | 2 | 2 | 2 | 2 | 2 | 2 | 2 |
| Component (B) | | | | | | | | |
| Type | B-1 | B-5 | B-1 | B-1 | B-1 | B-1 | B-1 | B-1 |
| Incorporated amount (parts by weight) | 3 | 3 | 3 | 2 | 2 | 2 | 5 | 2 |
| Component (C) | | | | | | | | |
| Type | Not used | Not used | Not used | C-1 | C-2 | C-3 | C-3 | C-4 |
| Incorporated amount (parts by weight) | — | — | — | 2 | 2 | 2 | 3 | 2 |
| Component (D) | | | | | | | | |
| Type | D-2 | D-2 | D-2 | Not used | Not used | Not used | Not used | Not used |
| Incorporated amount (parts by weight) | 2 | 2 | 4 | — | — | — | — | — |
| Kneading conditions | | | | | | | | |
| Extrusion temperature (° C.) | 250 | 250 | 250 | 250 | 250 | 250 | 260 | 250 |
| Speed of rotation (rmp) | 300 | 300 | 300 | 300 | 300 | 300 | 250 | 300 |
| Area-average particle size of the | | | | | | | | |
| component (B) | | | | | | | | |
| Particle size Df(μm) | 0.10 | 0.20 | 0.04 | 0.20 | 0.21 | 0.21 | 0.20 | 0.22 |
| Particle size ratio (Df/Dr) | 0.08 | 0.15 | 0.03 | 0.15 | 0.16 | 0.16 | 0.15 | 0.17 |
| Physical properties | | | | | | | | |
| Charpy impact strength (KJ/m²) | 7 | 6 | 6 | 6 | 6 | 7 | 9 | 7 |
| Falling dart impact strength (kg · cm) | 19 | 17 | 19 | 18 | 19 | 18 | 41 | 19 |
| Falling dart impact strength | 95 | 85 | 95 | 90 | 95 | 90 | 91 | 95 |
| retention (%) | | | | | | | | |
| Flexural modulus (MPa) | 2,650 | 2,600 | 2,550 | 2,650 | 2,600 | 2,610 | 2,520 | 2,620 |
| Thermal deformation temperature (° C.) | 73 | 72 | 68 | 72 | 70 | 71 | 71 | 72 |
| Melt flow rate (g/10 minutes) | 8 | 9 | 10 | 11 | 11 | 10 | 10 | 9 |
| Spiral flow (cm) | 45 | 47 | 48 | 49 | 49 | 48 | 55 | 50 |
| Gloss (%) | 78 | 75 | 78 | 78 | 78 | 78 | 75 | 78 |
| Gloss retention (%) | 100 | 96 | 100 | 100 | 100 | 100 | 100 | 100 |
| Releasability | ⊚ | ⊚ | ⊚ | ◯ | ⊚ | ⊚ | ◯ | ⊚ |
| Mold contamination resistance | ◯ | ◯ | ◯ | Δ | ◯ | ◯ | ◯ | ◯ |
| UL94 fire retardancy (3.0 mm) | V-2 | V-2 | V-2 | V-2 | V-2 | V-2 | V-2 | V-2 |
| UL94 fire retardancy (1.5 mm) | V-2 | V-2 | Not passed | V-2 | V-2 | V-2 | V-2 | V-2 |
| Self-extinguishing time of dripped resin | X | X | X | X | X | X | Δ | X |
| composition | | | | | | | | |

TABLE 9

| | Example | Example | Example | Example | Comparative | Comparative | Example |
|---|---|---|---|---|---|---|---|
| | 34 | 35 | 36 | 37 | Example 12 | Example 13 | 38 |
| Component (A) | | | | | | | |
| HIPS type | HIPS2 | HIPS2 | HIPS2 | HIPS2 | HIPS2 | HIPS2 | HIPS2 |
| Incorporated amount (parts by weight) | 100 | 100 | 100 | 100 | 100 | 100 | 100 |
| Incorporated amount of PPE (parts by | 3 | 3 | 3 | 3 | 3 | 5 | 5 |
| weight) | | | | | | | |
| Residue after thermal weight loss (%) | 3 | 3 | 3 | 3 | 3 | 4 | 4 |
| Component (B) | | | | | | | |
| Type | B-1 | B-1 | B-1 | B-1 | B-1 | Not used | B-1 |
| Incorporated amount (parts by weight) | 2 | 7 | 7 | 7 | 7 | — | 3 |
| Kneading conditions | | | | | | | |
| Extrusion temperature (° C.) | 250 | 250 | 250 | 220 | 180 | 250 | 250 |
| Speed of rotation (rmp) | 300 | 300 | 200 | 200 | 250 | 300 | 300 |
| Area-average particle size of the | | | | | | | |
| component (B) | | | | | | | |
| Particle size Df(μm) | 0.15 | 0.25 | 1.2 | 1.4 | 3.6 | — | 0.15 |
| Particle size ratio (Df/Dr) | 0.12 | 0.19 | 0.92 | 1.1 | 2.8 | — | 0.12 |
| Physical properties | | | | | | | |
| Charpy impact strength (KJ/m²) | 10 | 8 | 6 | 5 | 4 | 12 | 10 |
| Falling dart impact strength (kg · cm) | 30 | 22 | 20 | 15 | 11 | 50 | 45 |
| Flexural modulus (MPa) | 2,650 | 2,800 | 2,750 | 2,720 | 2,670 | 2,650 | 2,670 |
| Thermal deformation temperature (° C.) | 76 | 77 | 77 | 76 | 75 | 77 | 77 |
| Melt flow rate (g/10 minutes) | 6 | 6 | 6 | 6 | 6 | 5 | 5 |
| Spiral flow (cm) | 42 | 48 | 47 | 47 | 46 | 38 | 40 |
| Gloss (%) | 78 | 76 | 73 | 71 | 64 | 78 | 77 |
| Gloss retention (%) | 100 | 97 | 94 | 91 | 82 | 100 | 99 |
| Releasability | ⊚ | ⊚ | ◯ | ◯ | Δ | Δ | ◯ |
| Mold contamination resistance | ◯ | ◯ | ◯ | ◯ | ◯ | ◯ | ◯ |
| UL94 fire retardancy (3.0 mm) | V-2 | V-2 | V-2 | V-2 | Not passed | Not passed | V-2 |
| UL94 fire retardancy (1.5 mm) | V-2 | V-2 | V-2 | V-2 | V-2 | Not passed | V-2 |
| Self-extinguishing time of dripped resin | ◯ | ⊚ | ⊚ | Δ | Δ | X | ◯ |
| composition | | | | | | | |

TABLE 10

| | Example | Example | Example | Example |
|---|---|---|---|---|
| | 39 | 40 | 41 | 42 |
| Component (A) | | | | |
| HIPS type | HIPS1 | HIPS3 | HIPS6 | HIPS7 |
| Incorporated amount | 100 | 100 | 100 | 100 |
| (parts by weight) | | | | |
| Incorporated amount of PPE | 5 | 5 | 5 | 5 |
| (parts by weight) | | | | |
| Residue after thermal | 4 | 4 | 4 | 4 |
| weight loss (%) | | | | |
| Component (B) | | | | |
| Type | B-1 | B-1 | B-1 | B-1 |
| Incorporated amount | 3 | 3 | 3 | 3 |
| (parts by weight) | | | | |
| Kneading conditions | | | | |
| Extrusion temperature (° C.) | 250 | 250 | 250 | 250 |
| Speed of rotation (rmp) | 300 | 300 | 300 | 300 |
| Area-average particle size of the | | | | |
| component (B) | | | | |
| Particle size Df(μm) | 0.12 | 0.11 | 0.12 | 0.12 |
| Particle size ratio (Df/Dr) | 0.08 | 0.09 | 0.29 | 0.09 |
| Physical properties | | | | |
| Charpy impact strength (KJ/m²) | 6 | 13 | 9 | 15 |
| Falling dart impact strength (kg · cm) | 20 | 50 | 45 | 50 |
| Flexural modulus (MPa) | 3,000 | 2,500 | 2,800 | 2,200 |
| Thermal deformation temperature (° C.) | 77 | 76 | 76 | 75 |
| Melt flow rate (g/10 minutes) | 7 | 5 | 8 | 7 |
| Spiral flow (cm) | 42 | 40 | 41 | 39 |
| Gloss (%) | 75 | 73 | 86 | 70 |
| Gloss retention (%) | 99 | 97 | 98 | 97 |
| Releasability | ◯ | ◯ | ◯ | Δ |
| Mold contamination resistance | ◯ | ◯ | ◯ | ◯ |
| UL94 fire retardancy | V-2 | V-2 | V-2 | V-2 |
| (3.0 mm) | | | | |
| UL94 fire retardancy | V-2 | V-2 | V-2 | V-2 |
| (1.5 mm) | | | | |
| Self-extinguishing time of dripped | ◯ | ◯ | ◯ | Δ |
| resin composition | | | | |

TABLE 11

| | Example | Example | Example | Example | Example | Example | Example |
|---|---|---|---|---|---|---|---|
| | 43 | 44 | 45 | 46 | 47 | 48 | 49 |
| Component (A) | | | | | | | |
| HIPS type | HIPS2 | HIPS2 | HIPS2 | HIPS2 | HIPS2 | HIPS2 | HIPS2 |
| Incorporated amount (parts by weight) | 100 | 100 | 100 | 100 | 100 | 100 | 100 |
| Incorporated amount of PPE (parts by | 5 | 5 | 5 | 5 | 5 | 7 | 7 |
| weight) | | | | | | | |
| Residue after thermal weight loss (%) | 4 | 4 | 4 | 4 | 4 | 5 | 5 |
| Component (B) | | | | | | | |
| Type | B-2 | B-3 | B-4 | B-5 | B-1 | B-1 | B-1 |
| Incorporated amount (parts by weight) | 5 | 5 | 5 | 5 | 7 | 3 | 10 |
| Kneading conditions | | | | | | | |
| Extrusion temperature (° C.) | 260 | 250 | 250 | 200 | 220 | 250 | 250 |
| Speed of rotation (rmp) | 300 | 300 | 300 | 300 | 300 | 300 | 300 |
| Area-average particle size of the | | | | | | | |
| component (B) | | | | | | | |
| Particle size Df(μm) | 0.2 | 0.25 | 0.09 | 0.35 | 0.1 | 0.12 | 0.10 |
| Particle size ratio (Df/Dr) | 0.15 | 0.19 | 0.07 | 0.27 | 0.08 | 0.09 | 0.08 |
| Physical properties | | | | | | | |
| Charpy impact strength (KJ/m²) | 8 | 8 | 9 | 6 | 9 | 12 | 6 |
| Falling dart impact strength (kg · cm) | 23 | 22 | 25 | 18 | 30 | 38 | 19 |
| Flexural modulus (MPa) | 2,750 | 2,750 | 2,780 | 2,750 | 2,900 | 3,010 | 3,050 |
| Thermal deformation temperature (° C.) | 75 | 75 | 74 | 76 | 79 | 81 | 82 |
| Melt flow rate (g/10 minutes) | 5 | 5 | 7 | 6 | 6 | 5 | 6 |
| Spiral flow (cm) | 40 | 43 | 42 | 40 | 45 | 40 | 45 |
| Gloss (%) | 78 | 77 | 78 | 75 | 76 | 78 | 72 |
| Gloss retention (%) | 100 | 99 | 100 | 96 | 97 | 100 | 92 |
| Releasability | ◯ | ◯ | ◯ | ◯ | ◯ | ◯ | ◯ |
| Mold contamination resistance | ◯ | ◯ | ◯ | ◯ | ◯ | ◯ | ◯ |
| UL94 fire retardancy (3.0 mm) | V-2 | V-2 | V-2 | V-2 | V-2 | V-2 | V-2 |
| UL94 fire retardancy (1.5 mm) | V-2 | V-2 | V-2 | V-2 | V-2 | V-2 | V-2 |
| Self-extinguishing time of dripped resin | ◯ | ◯ | ◯ | ◯ | ◯ | ⊚ | ⊚ |
| composition | | | | | | | |

TABLE 12

| | Example | Example | Example |
|---|---|---|---|
| | 50 | 51 | 52 |
| Component (A) | | | |
| HIPS type | HIPS2 | HIPS2 | HIPS2 |
| Incorporated amount | 100 | 100 | 100 |
| (parts by weight) | | | |
| Incorporated amount of PPE | 10 | 5 | 10 |
| (parts by weight) | | | |
| Residue after thermal weight | 6 | 4 | 6 |
| loss (%) | | | |
| Component (B) | | | |
| Type | B-1 | B-1 | B-1 |
| Incorporated amount | 3 | 12 | 10 |
| (parts by weight) | | | |
| Kneading conditions | | | |
| Extrusion temperature (° C.) | 250 | 250 | 250 |
| Speed of rotation (rmp) | 300 | 300 | 300 |
| Area-average particle size of the | | | |
| component (B) | | | |
| Particle size Df(μm) | 0.12 | 0.30 | 0.35 |
| Particle size ratio (Df/Dr) | 0.09 | 0.23 | 0.27 |
| Physical properties | | | |
| Charpy impact strength (KJ/m²) | 12 | 5 | 7 |
| Falling dart impact strength (kg · cm) | 50 | 11 | 18 |
| Flexural modulus (MPa) | 3,100 | 2,880 | 3,150 |
| Thermal deformation temperature | 82 | 78 | 83 |
| (° C.) | | | |
| Melt flow rate (g/10 minutes) | 4 | 6 | 5 |
| Spiral flow (cm) | 30 | 50 | 37 |
| Gloss (%) | 77 | 70 | 68 |
| Gloss retention (%) | 99 | 90 | 87 |
| Releasability | Δ | ◯ | Δ |
| Mold contamination resistance | ◯ | ◯ | ◯ |
| UL94 fire retardancy | V-2 | V-2 | V-2 |
| (3.0 mm) | | | |
| UL94 fire retardancy | V-2 | V-2 | V-2 |
| (1.5 mm) | | | |
| Self-extinguishing time of dripped | ⊚ | ⊚ | ⊚ |
| resin composition | | | |

TABLE 13

| | Example | Example | Example | Comparative | Example | Example | Example | Example |
|---|---|---|---|---|---|---|---|---|
| | 53 | 54 | 55 | Example 14 | 56 | 57 | 58 | 59 |
| Component (A) | | | | | | | | |
| HIPS type | HIPS2 | HIPS2 | HIPS2 | HIPS2 | HIPS2 | HIPS3 | HIPS2 | HIPS2 |
| Incorporated amount (parts by weight) | 100 | 100 | 100 | 100 | 100 | 100 | 100 | 100 |
| Incorporated amount of PPE (parts by | 2 | 5 | 5 | 5 | 5 | 10 | 5 | 5 |
| weight) | | | | | | | | |
| Residue after thermal weight loss (%) | 3 | 4 | 4 | 4 | 4 | 6 | 4 | 4 |
| Component (B) | | | | | | | | |
| Type | B-1 | B-1 | B-1 | Not used | B-1 | B-1 | B-5 | B-5 |
| Incorporated amount (parts by weight) | 3 | 3 | 3 | — | 3 | 5 | 5 | 5 |
| Component (C) | | | | | | | | |
| Type | C-3 | C-3 | C-4 | C-3 | C-3 | C-3 | Not used | Not used |
| Incorporated amount (parts by weight) | 3 | 7 | 7 | 7 | 10 | 3 | — | — |
| Component (D) | | | | | | | | |
| Type | Not used | Not used | Not used | Not used | Not used | Not used | D-1 | D-2 |
| Incorporated amount (parts by weight) | — | — | — | — | — | — | 2 | 2 |
| Kneading conditions | | | | | | | | |
| Extrusion temperature (° C.) | 250 | 250 | 250 | 250 | 250 | 260 | 250 | 250 |
| Speed of rotation (rmp) | 300 | 300 | 300 | 300 | 300 | 250 | 300 | 300 |
| Area-average particle size of the | | | | | | | | |
| component (B) | | | | | | | | |
| Particle size Df(μm) | 0.20 | 0.20 | 0.22 | — | 0.21 | 0.15 | 0.10 | 0.11 |
| Particle size ratio (Df/Dr) | 0.15 | 0.15 | 0.17 | — | 0.16 | 0.13 | 0.08 | 0.08 |
| Physical properties | | | | | | | | |
| Charpy impact strength (KJ/m²) | 8 | 6 | 6 | 8 | 4 | 8 | 8 | 8 |
| Falling dart impact strength (kg · cm) | 25 | 20 | 22 | 25 | 15 | 58 | 25 | 27 |
| Flexural modulus (MPa) | 2,550 | 2,440 | 2,450 | 2,420 | 2,380 | 2,590 | 2,800 | 2,750 |
| Thermal deformation temperature (° C.) | 73 | 70 | 72 | 70 | 68 | 73 | 77 | 76 |
| Melt flow rate (g/10 minutes) | 8 | 10 | 8 | 8 | 12 | 9 | 8 | 8 |
| Spiral flow (cm) | 45 | 53 | 50 | 50 | 55 | 35 | 45 | 45 |
| Gloss (%) | 78 | 78 | 78 | 78 | 78 | 75 | 77 | 77 |
| Gloss retention (%) | 100 | 100 | 100 | 100 | 100 | 96 | 99 | 99 |
| Releasability | ◯ | ◯ | ◯ | Δ | ◯ | ◯ | ◯ | ◯ |
| Mold contamination resistance | ◯ | ◯ | ◯ | ◯ | Δ | ◯ | ◯ | ◯ |
| UL94 fire retardancy (3.0 mm) | V-2 | V-2 | V-2 | Not passed | V-2 | V-2 | V-2 | V-2 |
| UL94 fire retardancy (1.5 mm) | V-2 | V-2 | V-2 | Not passed | V-2 | V-2 | V-2 | V-2 |
| Self-extinguishing time of dripped | ◯ | ⊚ | ⊚ | X | ⊚ | ⊚ | ◯ | ◯ |
| resin composition | | | | | | | | |

TABLE 14

| | Example | Example | Comparative | Example | Example | Example | Example |
|---|---|---|---|---|---|---|---|
| | 60 | 61 | Example 15 | 62 | 63 | 64 | 65 |
| Component (A) | | | | | | | |
| HIPS type | HIPS10 | HIPS2 | HIPS2 | HIPS10 | HIPS10 | HIPS10 | HIPS2 |
| Incorporated amount (parts by weight) | 85 | 85 | 85 | 85 | 85 | 80 | 80 |
| Incorporated amount of PPE (parts by | 15 | 15 | 15 | 15 | 15 | 20 | 20 |
| weight) | | | | | | | |
| Residue after thermal weight loss (%) | 8 | 8 | 8 | 8 | 8 | 12 | 12 |
| Component (B) | | | | | | | |
| Type | B-1 | B-1 | B-1 | B-1 | B-1 | B-1 | B-1 |
| Incorporated amount (parts by weight) | 15 | 15 | 15 | 10 | 10 | 15 | 15 |
| Component (C) | | | | | | | |
| Type | Not used | Not used | Not used | C-3 | C-4 | Not used | Not used |
| Incorporated amount (parts by weight) | — | — | — | 8 | 8 | — | — |
| Component (D) | | | | | | | |
| Type | Not used | Not used | Not used | Not used | Not used | Not used | D-1 |
| Incorporated amount (parts by weight) | — | — | — | — | — | — | 5 |
| Kneading conditions | | | | | | | |
| Extrusion temperature (° C.) | 260 | 260 | 200 | 260 | 260 | 270 | 270 |
| Speed of rotation (rmp) | 250 | 250 | 200 | 250 | 250 | 250 | 250 |
| Area-average particle size of the | | | | | | | |
| component (B) | | | | | | | |
| Particle size Df(μm) | 0.12 | 0.12 | 3.3 | 0.12 | 0.12 | 0.12 | 0.1 |
| Particle size ratio (Df/Dr) | 0.09 | 0.09 | 2.53 | 0.09 | 0.09 | 0.09 | 0.08 |
| Physical properties | | | | | | | |
| Charpy impact strength (KJ/m²) | 7 | 5 | 4 | 8 | 9 | 7 | 8 |
| Falling dart impact strength (kg · cm) | 48 | 28 | 17 | 55 | 58 | 57 | 61 |
| Thermal deformation temperature (° C.) | 85 | 86 | 84 | 73 | 74 | 90 | 85 |
| Melt flow rate (g/10 minutes) | 5 | 5 | 4 | 8 | 8 | 3 | 6 |
| Gloss (%) | 65 | 73 | 55 | 66 | 66 | 63 | 68 |
| Gloss retention (%) | 92 | 94 | 71 | 93 | 93 | 89 | 87 |
| Releasability | ◯ | ◯ | X | ⊚ | ⊚ | ⊚ | ⊚ |
| Mold contamination resistance | ◯ | ◯ | ◯ | ◯ | ◯ | ◯ | ◯ |
| UL94 fire retardancy (3.0 mm) | V-1 | V-1 | Not passed | V-0 | V-0 | V-0 | V-0 |

TABLE 15

| | Comparative | Comparative | Comparative | Comparative | Comparative |
|---|---|---|---|---|---|
| | Example 16 | Example 17 | Example 18 | Example 19 | Example 20 |
| Component (A) | | | | | |
| HIPS type | HIPS9 | HIPS9 | HIPS3 | HIPS3 | HIPS3 |
| Incorporated amount (parts by weight) | 80 | 80 | 55 | 80 | 100 |
| Incorporated amount of PPE (parts by | 20 | 20 | 45 | 20 | 0 |
| weight) | | | | | |
| Residue after thermal weight loss (%) | 12 | 12 | 22 | 12 | 2 |
| Component (B) | | | | | |
| Type | Not used | Not used | B-1 | B-6 | B-6 |
| Incorporated amount (parts by weight) | — | — | 5 | 10 | 30 |
| Component (C) | | | | | |
| Type | C-3 | C-3 | Not used | Not used | Not used |
| Incorporated amount (parts by weight) | 15 | 15 | — | — | — |
| Component (D) | | | | | |
| Type | Not used | Not used | Not used | Not used | Not used |
| Incorporated amount (parts by weight) | — | — | — | — | — |
| Kneading conditions | | | | | |
| Extrusion temperature (° C.) | 270 | 270 | 280 | 220 | 220 |
| Speed of rotation (rmp) | 250 | 250 | 250 | 250 | 250 |
| Area-average particle size of the | | | | | |
| component (B) | | | | | |
| Particle size Df(μm) | — | — | 0.1 | 1.3 | 2.5 |
| Particle size ratio (Df/Dr) | — | — | 0.08 | 1.0 | 1.92 |
| Physical properties | | | | | |
| Charpy impact strength (KJ/m²) | 8 | 8 | 12 | 7 | 4 |
| Falling dart impact strength (kg · cm) | 75 | 80 | 96 | 33 | 5 |
| Thermal deformation temperature (° C.) | 72 | 70 | 100 | 78 | 68 |
| Melt flow rate (g/10 minutes) | 6 | 7 | 0.5 | 4 | 12 |
| Gloss (%) | 70 | 71 | 65 | 65 | 60 |
| Gloss retention (%) | 99 | 100 | 87 | 87 | 80 |
| Releasability | Δ | ⊚ | X | X | X |
| Mold contamination resistance | Δ | X | ◯ | Δ | Δ |
| UL94 fire retardancy (3.0 mm) | V-1 | V-1 | V-0 | V-0 | V-0 |

*) The composition prepared in Comparative Example 16 was incorporated with zinc stearate as a releasing agent at 1.0 part.

### INDUSTRIAL APPLICABILITY

The fire-retardant styrenic resin composition of the present invention contains no halogen compound, exhibits excellent fire retardancy, well-balanced rigidity, heat resistance, fluidity for thin-wall products, falling dart impact strength and outer appearances, and good releasability and mold contamination resistance. As such, it is suitable as a fire-retardant material which satisfies the V-2 requirements for the internal portions of thin, complex-shape electronic/electric devices. It is also suitable as a V-2 fire-retardant material for the external portions of thin, complex-shape electronic/electric devices, e.g., audio and DVD devices and the like. It is also suitable as a V-1, V-0 or 5V fire-retardant material for the external portions of large-size, complex-shape electronic/electric devices, e.g., TV sets and the like.

1. A fire-retardant styrenic resin composition comprising
100 parts by weight of a styrenic resin having a residue after thermal weight loss of below 20% at 500° C., and 0.5 to 50 parts by weight of a halogen compound-free fire retardant component,
said component (B) having a molecular weight of 200 to 2000, being dispersed in the form of circular or oval particles having an area-average particle size of 0.01 to 3 μm in the component (A), having a residue after thermal weight loss of 20% or more at 500° C. and having a melting point of 100 to 400° C.

2. The fire-retardant styrenic resin composition according to claim 1, wherein the component (A) is a rubber-modified styrenic resin, and a rubber-like polymer dispersed in the component (A) has an area-average particle size of 0.1 to 2.5 μm and satisfies the following formula (1):
0.01≦(Df/Dr)≦1.0 (1)
wherein Df is an area-average particle size of the component (B) and Dr is an area-average particle size of the rubber-like polymer dispersed in the component (A).

3. The fire-retardant styrenic resin composition according to claim 1 or 2, wherein the component (A) is a rubber-modified styrenic resin and the composition comprises 100 parts by weight of the component (A) and 0.5 to 20 parts by weight of the component (B).

4. The fire-retardant styrenic resin composition according to claim 1 or 2, wherein the component (A) is a rubber-modified styrenic resin, the composition comprises 100 parts by weight of the component (A) and 0.5 to 10 parts by weight of the component (B), and the rubber-like polymer dispersed in the component (A) has an area-average particle size of 0.1 to 2.5 μm and satisfies the following formula (2):
0.04≦(Df/Dr)≦1.0 (2)
wherein Df is an area-average particle size of the component (B) and Dr is an area-average particle size of the rubber-like polymer dispersed in the component (A).

5. The fire-retardant styrenic resin composition according to claim 1 or 2, wherein the component (A) is a rubber-modified styrenic resin comprising a blend of a rubber-modified polystyrenic resin and polyphenylene ether, the content of the rubber-modified polystyrenic resin in the blend being 70% by weight or more.

6. The fire-retardant styrenic resin composition according to claim 5, wherein the component (A) consists of a blend comprised of 100 parts by weight of the rubber-modified polystyrenic resin and 0.1 to 45 parts by weight of the polyphenylene ether, the content of the component (B) in the resin composition being 0.5 to 20 parts by weight, and the rubber-like polymer dispersed in the component (A) having an area-average particle size of 0.3 to 2.5 μm.

7. The fire-retardant styrenic resin composition according to claim 5, wherein the rubber-modified styrenic resin as component (A) consists of a blend comprised of 100 parts by weight of the rubber-modified polystyrenic resin and 0.1 to 8 parts by weight of the polyphenylene ether, wherein the content of the component (B) in the resin composition is 0.5 to 10 parts by weight.

8. The fire-retardant styrenic resin composition according to claim 5, wherein the incorporated part (X) of the polyphenylene ether in the component (A) and the incorporated part (Y) of the component (B) satisfy the following formula (3).
0.4≦(Y/X)≦2.0 (3)

9. The fire-retardant styrenic resin composition according to claim 1 or 2, wherein the component (C), which is a halogen compound-free fire retardant component other than the component (B), is incorporated into the composition in an amount of 0.1 to 40 parts by weight.

10. The fire-retardant styrenic resin composition according to claim 9, wherein the component (C) is incorporated into the composition in an amount of 0.1 to 10 parts by weight.

11. The fire-retardant styrenic resin composition according to claim 9, wherein the content of the component (C) in the composition is not more than that of the component (B).

12. The fire-retardant styrenic resin composition according to claim 1 or 2, wherein a polymer component (D) comprising an essential structural unit having at least one polar group is further incorporated as a compatibilizer in an amount of 0.2 to 10 parts by weight.

13. The fire-retardant styrenic resin composition according to claim 1 or 2, wherein the component (B) is a phosphorus-based fire retardant represented by the following formula (4): 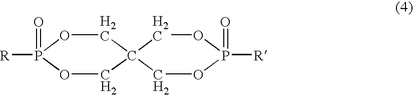
wherein R and R′ are each an alkyl group having 1 to 12 carbon atoms, a cycloalkyl group having 5 to 10 carbon atoms, an aralkyl group having 7 to 20 carbon atoms or an aryl group having 6 to 15 carbon atoms, and may be the same or different.

14. The fire-retardant styrenic resin composition according to claim 13, wherein both R and R′ in the formula (4) are a benzyl group.

15. The fire-retardant styrenic resin composition according to claim 1 or 2, wherein the component (B) is a phosphorus-based fire retardant represented by the following formula (5): 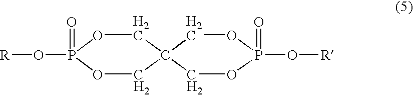
wherein R and R′ are each an alkyl group having 1 to 12 carbon atoms, a cycloalkyl group having 5 to 10 carbon atoms, an aralkyl group having 7 to 20 carbon atoms or an aryl group having 6 to 15 carbon atoms, and may be the same or different.

16. The fire-retardant styrenic resin composition according to claim 7, wherein the component (C) comprises a compound represented by the following formula (6): 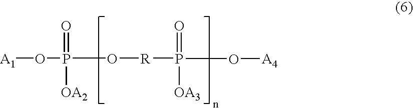
wherein n is an integer of 1 to 10; A1 to A4 are each independently a phenyl, tolyl or xylyl group, and when n is 2 or more, a plurality of A3s may be the same or different; and R is a group selected from the group consisting of the following formulas (R1) to (R4).

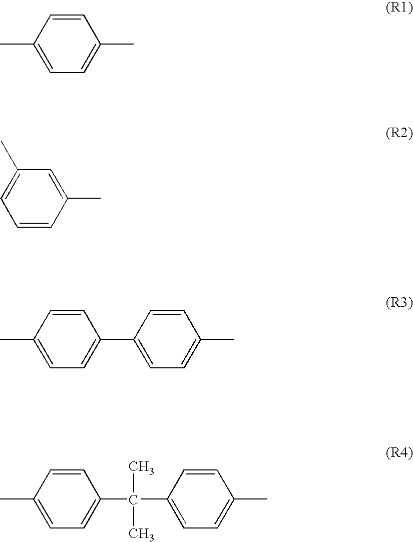

17. The fire-retardant styrenic resin composition according to claim 1 or 2, wherein the component (A) is a rubber-modified polystyrenic resin, the content (a) of a rubber-like polymer in the rubber-modified polystyrenic resin is 3 to 15% by weight, the proportion (b) of solvent-insolubles in the rubber-modified polystyrenic resin is 10 to 30% by weight, the formula [(b)/(a)]≦3.5 is satisfied, and the swelling index of the rubber-modified polystyrenic resin in toluene is 9.0 to 11.5.

18. The fire-retardant styrenic resin composition according to claim 1 or 2, wherein the component (A) is a rubber-modified polystyrenic resin comprising a high cis polybutadiene containing the cis 1,4 bond in an amount of 90% by mole or more, and
wherein the content (a) of a rubber-like polymer in the rubber-modified polystyrenic resin is 3 to 15% by weight, the proportion (b) of solvent-insolubles in the rubber-modified polystyrenic resin is 10 to 30% by weight, the formula 2.0≦[(b)/(a)]≦3.5 is satisfied, and the rubber-like polymer dispersed in the rubber-modified polystyrenic resin has an area-average particle size of 0.8 to 2.5 μm, the swelling index of the rubber-modified polystyrenic resin in toluene being 9.0 to 11.0.

19. The fire-retardant styrenic resin composition according to claim 1 or 2 which is used for the internal parts of an electric/electronic device satisfying the UL 94 V-2 standard.

20. The fire-retardant styrenic resin composition according to claim 19 which is used for the internal parts of an electric/electronic device satisfying the UL 94 V-2 standard and having an average thickness of 2 mm or less.

21. The fire-retardant styrenic resin composition according to claim 1 or 2 which is used for the external parts of an electric/electronic device satisfying the UL 94 V-2 standard.

22. The fire-retardant styrenic resin composition according to claim 21 which is used for the external parts of an electric/electronic device satisfying the UL 94 V-2 standard and having an average thickness of 2 mm or less.

23. The fire-retardant styrenic resin composition according to claim 1 or 2 which is used for the external parts of an electric/electronic device satisfying the UL 94 V-0 standard.

24. The fire-retardant styrenic resin composition according to claim 1 or 2 which is used for the external parts of an electric/electronic device satisfying the UL 94 5V standard.
